(19) United States
(12) Patent Application Publication
(10) Pub. No.: US 2019/0292288 A1
(43) Pub. Date: Sep. 26, 2019

(54) COPOLYMER, SEPARATION MEMBRANE, MEDICAL DEVICE, AND BLOOD PURIFIER USING THE COPOLYMER

(71) Applicant: TORAY INDUSTRIES, INC., Tokyo (JP)

(72) Inventors: Takeshi BABA, Otsu-shi (JP); Tomonori KAWAKAMI, Otsu-shi (JP); Suguru USHIRO, Otsu-shi (JP); Yoshiyuki UENO, Otsu-shi (JP)

(73) Assignee: Toray Industries, Inc., Tokyo (JP)

(21) Appl. No.: 16/319,557

(22) PCT Filed: Aug. 4, 2017
(86) PCT No.: PCT/JP2017/028339

§ 371 Date: Jan. 22, 2019

(30) Foreign Application Priority Data
Aug. 5, 2016 (JP) 2016-154760

(51) Int. Cl. C08F 226/10; C08F 218/10; C08F 220/56; C08F 220/12; B01D 71/76; B01D 71/38; B01D 71/40; B01D 61/24

(52) U.S. Cl. CPC C08F 226/10; C08F 218/10; C08F 220/56; B01D 61/243; B01D 71/76; B01D 71/38; B01D 71/40; C08F 220/12

(57) ABSTRACT

A copolymer is excellent in water permeability, suppression of platelet adhesion, and suppression of protein adhesion, and a separation membrane, a medical device, and a separation membrane module for medical use using the copolymer. The copolymer includes monomer units derived from two or more types of monomers, wherein the hydration energy density of the copolymer is 158.992 to 209.200 kJ·mol⁻¹·nm⁻³, the monomer unit with the highest hydration energy density in the monomer units is a monomer unit not containing a hydroxy group, the volume fraction of the monomer unit with the highest hydration energy density in the monomer units is 35 to 90%, and the difference in hydration energy density is 71.128 to 418.400 kJ·mol⁻¹·nm⁻³.

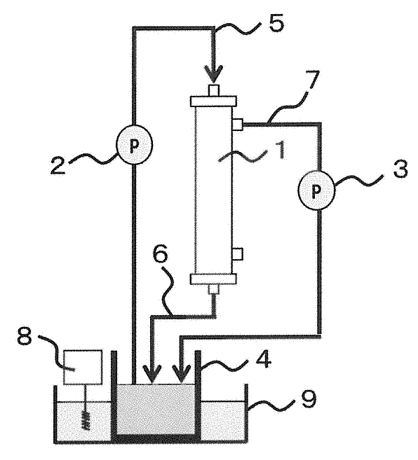

### TECHNICAL FIELD

This disclosure relates to a copolymer, a separation membrane, a medical device, and a blood purifier using the copolymer.

### BACKGROUND

In a separation membrane for medical use that contacts a body fluid or blood, adhesion of proteins and platelets becomes a cause for a decrease in performance of the separation membrane or produces a biological reaction, which has been a serious problem.

JPH 2-18695 B discloses a polysulfone-based polymer obtained by a method in which polyvinylpyrrolidone, which is a hydrophilic polymer, is mixed at a stage of a membrane-forming stock solution and the resultant mixture is molded so that hydrophilicity is imparted to the membrane and contamination is suppressed.

JPH 8-131791 A discloses a method of coating polyvinylacetal diethylamino-acetate and a hydrophilizing agent on a membrane to attempt to perform hydrophilization.

JPH 6-238139 A reports a method of bringing a separation membrane of a polysulfone-based polymer into contact with a solution of a hydrophilic polymer such as polyvinylpyrrolidone, and then forming a coating layer insolubilized by radiation crosslinking, while Kazunori Kataoka et al., Nano Bioengineering, Kyorin Tosho, 1st edition issued in October 2007, p. 115-116 reports that adhesion of proteins and the like can only be temporarily suppressed.

JP 2011-72987 A discloses a separation membrane of a polysulfone-based polymer in which a vinylpyrrolidone/vinyl acetate copolymer is introduced onto the surface.

However, to impart hydrophilicity to the surface of the polysulfone-based polymer mentioned in JP '695, a large amount of a hydrophilic polymer in a membrane-forming stock solution need to be used, and there was a limitation that the hydrophilic polymer imparted to the surface of the polysulfone-based polymer is limited to a hydrophilic polymer compatible with the base polymer.

In the method mentioned in JP '791, there is a concern that polyvinylacetal diethylaminoacetate covers a hydrophilizing agent, resulting in a sharp decrease in the effect on non-adhesion. Currently, when a membrane is immersed in each solution of polyvinylacetal diethylaminoacetate and a hydrophilizing agent, the separation performance of the membrane is also decreased.

In the methods mentioned in JP '139 and JP '987, when a hydrophilic polymer substance insolubilized in water is used for a medical device used in contact with a biological component such as blood for a long period of time, like a continuous blood purifier, blood coagulation and protein adhesion progress with time due to the contact with the biological component such as blood, eventually leading to clogging, and long-term continuous use is difficult. For example, a blood purifier poses a problem that adhesion of proteins to a membrane in the blood purifier and blood coagulation progress with time, and particularly in a continuous blood purifier used for treatment of acute renal failure, continuous use for one to several days is required, and thus it is imperative to make a specification in which adhesion of proteins and platelets is suppressed and high water permeability can be maintained.

Accordingly, it could be helpful to provide a copolymer that maintains high water permeability even when brought into contact with a biological component such as proteins and blood for a long period of time and suppresses adhesion of proteins and platelets.

As mentioned above, when the surface of a separation membrane is covered with a hydrophilic polymer such as polyvinylpyrrolidone, a sufficient effect to suppress adhesion of proteins and the like for a long period of time is not obtained, clogging occurs, and continuous use of the separation membrane becomes impossible. This is believed to be because when a polymer existing on a contact surface of a separation membrane of a medical device is too hydrophilic, the polymer and absorbed water of the polymer destabilize the structures of a protein and absorbed water of the protein so that adhesion of proteins cannot be sufficiently suppressed. Herein, the absorbed water means a water molecule existing near a copolymer existing on a contact surface of a material, or a water molecule existing near a protein.

### SUMMARY

We found that a copolymer including two or more types of monomer units and the hydration energy density of the copolymer and the monomer unit constituting the copolymer are important in designing a polymer that can suppress adhesion of proteins and platelets. We thus provide:
(1) A copolymer, comprising two or more types of monomer units,

wherein

a hydration energy density of the copolymer calculated based on Formula (1) is 38 to 50 cal·mol⁻¹·Å⁻³,

a monomer unit with a highest hydration energy density of monomer unit i calculated based on Formula (2) is a monomer unit not containing a hydroxy group,

a volume fraction of a monomer unit with a highest hydration energy density of monomer unit i calculated based on Formula (3) is 35 to 90%,

a difference in hydration energy density calculated by Formula (4) is 17 to 100 cal·mol⁻¹·Å⁻³,

Hydration energy density (kJ·mol⁻¹·mn⁻³) of copolymer=Σᵢ₌₁^{N}{(molar fraction of monomer unit i)×(hydration energy of monomer unit i)}/Σᵢ₌₁^{N}{(molar fraction of monomer unit i)×(volume of monomer unit i)} (1)

wherein the hydration energy of monomer unit i is an absolute value of a value obtained by subtracting energy in vacuum of monomer unit i from energy in water of monomer unit i, N represents a total number of monomer species constituting the copolymer, and i represents an integer of 1 or more and N or less,

Hydration energy density (kJ·mol⁻¹·nm⁻³) of monomer unit i=(hydration energy of monomer unit i)/(volume of monomer unit i) (2),

Volume fraction (%) of monomer unit with highest hydration energy density of monomer unit i=molar fraction of monomer unit with highest hydration energy density of monomer unit i×volume of monomer unit with highest hydration energy density of monomer unit i/Σᵢ₌₁^{N}{(molarfraction of monomer unit i)×(volume of monomer unit i)} (3),

wherein N and i are the same as defined above, and

Difference in hydration energy density (kJ·mol⁻·nm⁻³)=(hydration energy density of monomer unit with highest hydration energy density of monomer unit)−(hydration energy density of monomer unit with lowest hydration energy density of monomer unit) (4).
(2) The copolymer according to the abovementioned (1), wherein

the hydration energy density of the copolymer is 40 to 48 cal·mol⁻¹·Å⁻³,

the volume fraction of the monomer unit with the highest hydration energy density of monomer unit i is 40 to 80%, and

the difference in hydration energy density is 17 to 75 cal·mol⁻¹·Å⁻³.
(3) The copolymer according to the abovementioned (1) or (2), wherein the two or more types of monomer units comprise a hydrophobic monomer unit and a hydrophilic monomer unit.
(4) The copolymer according to the abovementioned (3), wherein

the hydrophobic monomer unit is a repeating unit in a homopolymer or a copolymer obtained by polymerizing monomers selected from the group consisting of vinyl carboxylate, methacrylate, acrylate, and a styrene derivative, and

the hydrophilic monomer unit is a repeating unit in a homopolymer or a copolymer obtained by polymerizing monomers selected from the group consisting of an allylamine derivative, a vinylamine derivative, N-vinylamide, an acrylamide derivative, a methacrylamide derivative, N-vinyl lactam and N-acryloylmorpholine.
(5) The copolymer according to the abovementioned (3) or (4), wherein

the hydrophobic monomer unit is a repeating unit in a homopolymer obtained by polymerizing vinyl carboxylate or a copolymer obtained by copolymerizing vinyl carboxylate, and

the hydrophilic monomer unit is a repeating unit in a homopolymer obtained by polymerizing N-vinyl lactam or a copolymer obtained by copolymerizing N-vinyl lactam.
(6) A separation membrane, comprising the copolymer according to any one of the abovementioned (1) to (5).
(7) A medical device, comprising the copolymer according to any one of the abovementioned (1) to (5).
(8) A blood purifier, comprising the separation membrane according to the abovementioned (6).

In Formula (1), Formula (2), and Formula (4), when the unit of hydration energy is converted from cal·mol⁻¹ to J·mol⁻¹, the copolymer in the abovementioned (1) can also be as follows. In this regard, one calorie (1 cal) was defined as 4.184 J.
(1) A copolymer, comprising two or more types of monomer units, wherein

a hydration energy density of the copolymer calculated based on Formula (1) is 158.992 to 209.200 kJ·mol⁻¹·nm⁻¹,

a monomer unit with a highest hydration energy density of monomer unit i calculated based on Formula (2) is a monomer unit not containing a hydroxy group,

a volume fraction of a monomer unit with a highest hydration energy density of monomer unit i calculated based on Formula (3) is 35 to 90%,

a difference in hydration energy density calculated by Formula (4) is 71.128 to 418.400 kJ·mol⁻¹·nm⁻³,

Hydration energy density (kJ·mol⁻¹·nm⁻³) of copolymer=Σᵢ₌₁^{N}{(molar fraction of monomer unit i)×(hydration energy of monomer unit i)}/Σᵢ₌₁^{N}{(molar fraction of monomer unit i)×(volume of monomer unit i)} (1),

wherein a hydration energy of monomer unit i is an absolute value of a value obtained by subtracting energy in vacuum of monomer unit i from energy in water of monomer unit i, N represents a total number of monomer species constituting the copolymer, and i represents an integer of 1 or more and N or less,

Hydration energy density (kj·mol⁻¹·nm⁻³) of monomer unit i=(hydration energy of monomer unit i)/(volume of monomer unit i) (2),

Volume fraction (%) of monomer unit with highest hydration energy density of monomer unit i=molar fraction of monomer unit with highest hydration energy density of monomer unit i×volume of monomer unit with highest hydration energy density of monomer unit i/Σᵢ₌₁^{N}{(molar fraction of monomer unit i)×(volume of monomer unit i)} (3),

wherein N and i are the same as defined above, and

Difference in hydration energy density (kJ·mol⁻¹·nm⁻³)=(hydration energy density of monomer unit with highest hydration energy density of monomer unit)−(hydration energy density of monomer unit with lowest hydration energy density of monomer unit) (4).

In Formula (1), Formula (2), and Formula (4), when the unit of hydration energy is converted from cal·mol⁻¹ to J·mol⁻¹, the copolymer of the abovementioned (2) can also be mentioned as follows. In this regard, one calorie (1 cal) was defined as 4.184 J.
(2) The copolymer according to the abovementioned (1), wherein

the hydration energy density of the copolymer is 167.360 to 200.832 kJ·mol⁻¹·nm⁻³,

the volume fraction of the monomer unit with the highest hydration energy density of monomer unit i is 40 to 80%, and

the difference in hydration energy density is 71.128 to 313.800 kJ·mol⁻¹·nm⁻³.

The copolymer is preferably a copolymer comprising two or more types of monomer units, wherein a hydration energy density of the copolymer calculated based on Formula (1) is 158.992 to 209.200 kJ·mol⁻¹·nm⁻³, a monomer unit with a highest hydration energy density of monomer unit i calculated based on Formula (2) is a monomer unit not containing a hydroxy group, a volume fraction of a monomer unit with a highest hydration energy density of monomer unit i calculated based on Formula (3) is 35 to 90%, and a difference in hydration energy density calculated by Formula (4) is 71.128 to 313.800 kJ·mol⁻¹·nm⁻³, more preferably a copolymer comprising two or more types of monomer units, wherein a hydration energy density of the copolymer calculated based on Formula (1) is 167.360 to 188.280 kJ·mol⁻¹·nm⁻³, a monomer unit with a highest hydration energy density of monomer unit i calculated based on Formula (2) is a monomer unit not containing a hydroxy group, a volume fraction of a monomer unit with a highest hydration energy density of monomer unit i calculated based on Formula (3) is 40 to 80%, and a difference in hydration energy density calculated by Formula (4) is 71.128 to 313.800 kJ·mol⁻¹·nm⁻³, and still more preferably a copolymer comprising two or more types of monomer units, wherein a hydration energy density of the copolymer calculated based on Formula (1) is 167.360 to 188.280 kJ·mol⁻¹·nm⁻³, a monomer unit with a highest hydration energy density of monomer unit i calculated based on Formula (2) is a monomer unit not containing a hydroxy group, a volume fraction of a monomer unit with a highest hydration energy density of monomer unit i calculated based on Formula (3) is 40 to 70%, and a difference in hydration energy density calculated by Formula (4) is 71.128 to 251.040 kJ·mol⁻¹·nm⁻³.

The copolymer can suppress adhesion of proteins and platelets and can maintain high water permeability even when used in contact with a biological component such as blood for a long period of time, and thus is highly useful as a separation membrane and particularly can be used as a medical device and a blood purifier.

### BRIEF DESCRIPTION OF THE DRAWING

The drawing is a schematic diagram showing a circuit used to measure the temporal change of a sieving coefficient of albumin.

### DESCRIPTION OF REFERENCE SYMBOLS

1 Hollow fiber membrane module
2 Bi pump
3 F pump
4 Circulation beaker
5 Bi circuit
6 Bo circuit
7 F circuit
8 Heater
9 Warm water bath

### DETAILED DESCRIPTION

Our copolymers, membranes, devices and purifiers will be described in detail below, but this disclosure is not limited to the following examples. The ratio of the drawing is not always consistent with that of the description.

The copolymer is a copolymer comprising two or more types of monomer units, wherein a hydration energy density of the copolymer calculated based on Formula (1) is 158.992 to 209.200 kJ·mol⁻¹·nm⁻³, a monomer unit with a highest hydration energy density of monomer unit i calculated based on Formula (2) is a monomer unit not containing a hydroxy group, a volume fraction of a monomer unit with a highest hydration energy density of monomer unit i calculated based on Formula (3) is 35 to 90%, and a difference in hydration energy density calculated by Formula (4) is 71.128 to 418.400 kJ·mol⁻¹·nm⁻³. Herein, 158.992 to 209.200 kJ·mol⁻¹·nm⁻³ is synonymous with 38 to 50 cal·mol⁻¹·Å⁻³, and 71.128 to 418.400 kJ·mol⁻¹·nm³ is synonymous with 17 to 100 cal·mol⁻¹·Å⁻³. In this regard, 1 cal was defined as 4.184 J.

“Monomer unit” refers to a repeating unit in a homopolymer or a copolymer obtained by polymerizing monomers. For example, hydrophobic monomer unit refers to a repeating unit in a homopolymer or a copolymer obtained by polymerizing hydrophobic monomers.

“Comprising two or more types of monomer units” means that two or more types of repeating units in a copolymer obtained by polymerizing monomers are included. For example, a vinylpyrrolidone/vinyl decanoate random copolymer includes two types of monomer units of vinylpyrrolidone and vinyl decanoate.

“Copolymer” means a polymer composed of two or more types of monomer units.

“Hydration energy” means an energy change obtained in a system when a solute is put in an aqueous solution. As the unit of hydration energy, for example, cal·mol⁻¹ or J·mol⁻¹ is used.

“Hydration energy of monomer unit” means an absolute value of a value obtained by subtracting energy in vacuum of a monomer unit from energy in water of the monomer unit.

“Hydration energy density” means hydration energy per unit volume. For example, in the case of monomer, it is a numerical value defined by Formula (2). The unit of hydration energy density depends on the unit of hydration energy, and, for example, cal·mol⁻¹·Å⁻³ or kJ·mol⁻¹·nm⁻³ is used.

“Difference in hydration energy density” means a numerical value defined by Formula (4).

“Monomer unit not containing hydroxy group” means that the structure of the monomer unit does not contain a hydroxy group.

“Monomer unit with highest hydration energy density of monomer unit i” means a monomer unit which has the highest hydration energy density defined by Formula (2) in monomer units i constituting a copolymer.

“Monomer unit with lowest hydration energy density of monomer unit i” means a monomer unit which has the lowest hydration energy density defined by Formula (2) in monomer units i constituting a copolymer.

With respect to the molecular model of the monomer unit, for example, when the monomer unit is a structure represented by the chemical formula of Formula (I), a structure represented by the chemical formula of Formula (II) is included in calculation. In other words, a structure in which the carbon terminal on a side to which a side chain R is bound is terminated with a methyl group ((a) in Formula (II)) and the carbon terminal on a side to which a side chain R is not bound is terminated with a hydrogen atom ((b) in Formula (II)) is used.

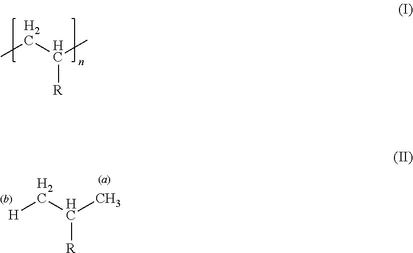

Energy in vacuum and energy in water of the monomer unit in Formula (1) can be calculated by the following method.

First, structure optimization of a molecular model of the monomer unit is performed. Density functional theory is used for the structure optimization. B3LYP is used for the functional, and 6-31G(d,p) is used for the basis function. In addition, opt is set as a keyword entered in an input file.

Next, energy in vacuum and energy in water are calculated for the optimized structure.

In calculation of energy in vacuum, density functional theory is used. B3LYP is used for the functional, and 6-31G(d,p) is used for the basis function.

In calculation of energy in water, density functional theory is used. B3LYP is used for the functional, and 6-31G(d,p) is used for the basis function. In addition, a polarizable continuum model is used for calculation of energy in water, and the following parameters are used as keywords:
SCRF=(PCM, G03Defaults, Read, Solvent=Water)
Radii=UAHF
Alpha=1.20.

When SCF energy in vacuum and water is calculated, the hydration energy of the monomer unit is determined. Herein, SCF energy is a value of E written in a row of “SCF Done:.”

For the energy calculation, quantum chemical calculation software Gaussian09, Revision D.01 (registered trademark) manufactured by Gaussian, Inc. is used.

In the copolymer, the hydration energy density of the copolymer is defined based on Formula (1):

Hydration energy density (kJ·mol⁻¹·nm⁻³) of copolymer−Σᵢ₌₁^{N}{(molar fraction of monomer unit i)×(hydration energy of monomer unit i)}/Σᵢ₌₁^{N}{(molar fraction of monomer unit i)×(volume of monomer unit i)} (1),

wherein a hydration energy of monomer unit i is an absolute value of a value obtained by subtracting energy in vacuum of monomer unit i from energy in water of monomer unit i, N represents a total number of monomer species constituting the copolymer, and i represents an integer of 1 or more and N or less.

The volume of the monomer unit can be calculated using, for example, the Connollysurface method in MaterialsStudio (registered trademark) manufactured by BIOVIA Corp. In that case, the parameters set are as follows:
Gridresolution=Coarse
Gridinterval=0.75 Å (0.075 nm)
vdWfactor=1.0
Connollyradius=1.0 Å (0.1 nm).

For the volume of the monomer unit in Formula (1), the optimized structure is used.

As the unit of the hydration energy density of the copolymer, for example, cal·mol⁻¹·Å⁻³ or kJ·mol⁻¹·nm⁻³ is used.

The hydration energy density of the copolymer is 38 to 50 cal·mol⁻¹·Å⁻³, preferably 40 to 48 cal·mol⁻¹·Å⁻³, more preferably 40 to 45 cal·mol⁻¹·Å⁻³, and still more preferably 40 to 44 cal·mol⁻¹·Å⁻³. Any preferable lower limit can be combined with any preferable upper limit. In other words, the hydration energy density of the copolymer is 158.992 to 209.200 kJ·mol⁻¹·nm⁻³, preferably 167.360 to 200.832 kJ·mol⁻¹·nm⁻³, more preferably 167.360 to 188.280 kJ·mol⁻¹·nm⁻³, and still more preferably 167.360 to 184.096 kJ·mol⁻¹·nm⁻³. Any preferable lower limit can be combined with any preferable upper limit.

The upper limit of the total number N of monomer species constituting the copolymer is not particularly limited, and preferably 2 to 5, more preferably 2 to 3, and most preferably 2.

We believe that when the hydration energy density of the entire copolymer is out of the abovementioned range, the copolymer and absorbed water of the copolymer destabilize the structures of a protein and absorbed water of the protein. As a result, the electrostatic interaction or the hydrophobic interaction between the copolymer existing on a material surface and a protein causes protein adhesion. Generally, when a polarized functional group such as a carbonyl group (e.g., an ester group and an amide group) is included in a molecule, hydration energy tends to be higher, compared with an alkyl group. The numerical value of hydration energy density becomes higher when the volume of a monomer is lower as long as hydration energy is the same. Therefore, the hydration energy density of the entire copolymer can meet the abovementioned range by adjusting a molar fraction. Examples of the sequence of a hydrophilic monomer unit and a hydrophobic monomer unit in the copolymer include a graft copolymer, a block copolymer, an alternating copolymer, and a random copolymer. Among them, a block copolymer, an alternating copolymer, and a random copolymer are preferred from the viewpoint of a high protein and platelet adhesion suppressing function, and a random copolymer or an alternating copolymer is more preferred from the viewpoint of an appropriate balance between hydrophilicity and hydrophobicity in one molecule. A copolymer in which at least a part of monomer sequences are randomly arranged is regarded a random copolymer.

In the monomer unit, a monomer unit with a highest hydration energy density calculated based on Formula (2) is a monomer unit not containing a hydroxy group. It is known that use of regenerated cellulose, which is a material first developed as a blood permeable membrane material, causes transient leukopenia (Hidemune Naito, Biocompatibility of Dialytic Membrane, Tokyo Igakusha Ltd., 1st edition issued on Mar. 25, 2010, p. 19). This is because a hydroxy group possessed by regenerated cellulose activates a complement system. To prevent such phenomenon, the monomer unit shall be a monomer unit not containing a hydroxy group.

Hydration energy density (kJ·mol⁻¹·nm⁻³) of monomer unit i=(hydration energy of monomer unit i)/(volume of monomer unit i) (2),

The molar fraction of Formula (1) and Formula (3) is calculated from the peak area measured with a nuclear magnetic resonance (NMR) apparatus as mentioned later. When the molar fraction cannot be calculated by NMR measurement for reasons such as overlap of peaks, the molar fraction may be calculated by elemental analysis.

Volume fraction (%) of monomer unit with highest hydration energy density of monomer unit i=molar fraction of monomer unit with highest hydration energy density of monomer unit i×volume of monomer unit with highest hydration energy density of monomer unit i/Σᵢ₌₁^{N}{(molarfraction of monomer unit i)×(volume of monomer unit i)} (3),

wherein N and i are the same as defined above.

“Biological component” means a substance containing proteins, lipids, and carbohydrates possessed by a living body, in addition to blood and body fluids constituting the living body, and among them, blood is preferable as the subject.

If the number average molecular weight of the copolymer is too low, the effect may not be sufficiently exerted and adhesion of proteins and platelets may become difficult to suppress when the copolymer is introduced onto a material surface. Thus, the number average molecular weight is preferably 2,000 or more, and more preferably 3,000 or more. On the other hand, the upper limit of the number average molecular weight of the copolymer is not particularly limited, but the number average molecular weight is preferably 1,000,000 or less, more preferably 100,000 or less, and still more preferably 50,000 or less since the efficiency of introduction onto a material surface may decrease if the number average molecular weight is too high.

In the copolymer, the volume fraction of the monomer unit with the highest hydration energy density of monomer unit i calculated based on Formula (3) is 35% to 90%, preferably 40% to 80%, more preferably 40% to 75%, and still more preferably 40% to 70%. Any preferable lower limit can be combined with any preferable upper limit.

We believe that when the volume fraction is in the abovementioned range, both effects of a hydrophilic monomer unit and a hydrophobic monomer unit lead to appropriate magnitude of interaction by the copolymer existing on a material surface and absorbed water of the copolymer to a protein and absorbed water of the protein, resulting in suppression of adhesion of proteins.

In the copolymer, the difference in hydration energy density is calculated by Formula (4):

Difference in hydration energy density (kJ·mol⁻¹·nm⁻³)=(hydration energy density of monomer unit with highest hydration energy density of monomer unit)−(hydration energy density of monomer unit with lowest hydration energy density of monomer unit) (4).

The difference in hydration energy density is 17 to 100 cal·mol⁻¹·Å⁻³, preferably 17 to 75 cal·mol⁻¹·Å⁻³, and more preferably 17 to 60 cal·mol⁻¹·Å⁻³. Any preferable lower limit can be combined with any preferable upper limit. In other words, the difference in hydration energy density is 71.128 to 418.400 kJ·mol⁻¹·nm⁻³, preferably 71.128 to 313.800 kJ·mol⁻¹·nm⁻³, and more preferably 71.128 to 251.040 kJ·mol⁻¹·nm⁻³. Any preferable lower limit can be combined with any preferable upper limit.

The hydration energy density, the volume fraction, and the difference in hydration energy density may be optionally combined.

We believe that when the difference in hydration energy density is in the abovementioned range, a hydrophilic monomer unit of a copolymer existing on a material surface can play a role in retaining absorbed water and a hydrophobic monomer unit can play a role in controlling the mobility of absorbed water. As a result, we believe that the interaction of the copolymer existing on a material surface and absorbed water of the copolymer to a protein and absorbed water of the protein becomes appropriate magnitude, resulting in suppression of adhesion of proteins.

The two or more types of monomer units preferably comprise a hydrophobic monomer unit and a hydrophilic monomer unit.

“Hydrophobic monomer unit” means a monomer unit with a lower hydration energy density than that of a hydrophilic monomer unit, and, for example, a repeating unit in a homopolymer or a copolymer obtained by polymerizing monomers selected from the group consisting of vinyl carboxylate, methacrylate, acrylate, and a styrene derivative is suitably used. Among them, a repeating unit in a homopolymer obtained by polymerizing vinyl carboxylate or a copolymer obtained by copolymerizing vinyl carboxylate is more preferable, and a repeating unit in a homopolymer obtained by polymerizing vinyl carboxylate is more preferable since a balance with a hydrophilic monomer unit and the mobility of absorbed water existing on a material surface is easily controlled.

The vinyl carboxylate means vinyl carboxylate ester, and examples thereof include aromatic vinyl carboxylate and aliphatic vinyl carboxylate. Examples of the aromatic vinyl carboxylate include vinyl benzoate, vinyl alkylbenzoate, vinyl oxybenzoate, and vinyl chlorbenzoate, but the aromatic vinyl carboxylate is not particularly limited. Examples of the aliphatic vinyl carboxylate include saturated vinyl carboxylates such as vinyl acetate, vinyl propionate, vinyl butyrate, vinyl valerate, vinyl caproate, vinyl laurate or vinyl palmitate, and unsaturated vinyl carboxylates such as vinyl acrylate, vinyl methacrylate, vinyl crotonate or vinyl sorbate, and the aliphatic vinyl carboxylate is not particularly limited. These aromatic vinyl carboxylates or aliphatic vinyl carboxylates may have a substituent as long as it does not impair the desired result.

“Hydrophilic monomer unit” means a monomer unit with higher hydration energy density than that of a hydrophobic monomer unit, and, for example, a repeating unit in a homopolymer or a copolymer obtained by polymerizing monomers selected from the group consisting of an allylamine derivative, a vinylamine derivative, N-vinylamide, an acrylamide derivative, a methacrylamide derivative, N-vinyl lactam, and N-acryloylmorpholine is suitably used. Among them, a repeating unit in a homopolymer obtained by polymerizing N-vinyl lactam or a copolymer obtained by copolymerizing N-vinyl lactam is preferable, and a repeating unit in a homopolymer obtained by polymerizing N-vinyl lactam is more preferable since the interaction with absorbed water existing on a material surface is not too strong and a balance with a hydrophobic monomer unit is easily kept. Among them, a repeating unit in a homopolymer obtained by polymerizing vinylpyrrolidone or a copolymer obtained by copolymerizing vinylpyrrolidone is still more preferable, and a homopolymer obtained by polymerizing vinylpyrrolidone is most preferable.

The allylamine derivative means an organic compound having an allyl group (CH₂═CH—CH₂—) and an amino group (—NH₂, —NH, or —N), and examples of the allylamine derivative include allylamine, N-methylallylamine, N-isopropylallylamine, and N-tert-butylallylamine. The allylamine derivative may have a substituent as long as it does not impair the desired result.

The vinylamine derivative means an organic compound having a vinylamine structure (CH₂═CH—NH—), and examples of the vinylamine derivative include vinylamine and vinylhydrazine. The vinylamine derivative may have a substituent as long as it does not impair the desired result.

The N-vinylamide means an organic compound having an N-vinylamide structure (CH₂═CH—NH—CO—), and examples thereof include N-vinylcarboxylic acid amide. Examples of the N-vinylcarboxylic acid amide include N-vinylacetamide, N-vinylpropionamide, N-vinylbutyric acid amide, and N-vinylbenzamide. The N-vinylamide may have a substituent as long as it does not impair the desired result.

The acrylamide derivative means an organic compound having an acrylamide structure (CH₂═CH—CO—NH—), and examples of the acrylamide derivative include acrylamide, N-isopropylacrylamide, N-tert-butylacrylamide, and N-phenylacrylamide. The acrylamide derivative may have a substituent as long as it does not impair the desired result.

The methacrylamide derivative means an organic compound having a methacrylamide structure (CH₂═C(CH₃)—CO—NH—), and examples of the methacrylamide derivative include methacrylamide, N-isopropylmethacrylamide, and N-phenylmethacrylamide. The methacrylamide derivative may have a substituent as long as it does not impair the desired result.

The hydrophobic monomer unit and the hydrophilic monomer unit may be optionally combined. Examples of the combination include vinyl carboxylate and N-vinylamide, and acrylate and an acrylamide derivative, and the like. As long as the action and function of the copolymer are not impaired, namely, in the range meeting the abovementioned (1) to (8), a different monomer, for example, a monomer including a reactive group such as a glycidyl group may be copolymerized.

Examples of the sequence of a hydrophilic monomer unit and a hydrophobic monomer unit in the copolymer include a graft copolymer, a block copolymer, an alternating copolymer, and a random copolymer. Among them, a block copolymer, an alternating copolymer, and a random copolymer are preferred from the viewpoint of a high protein and platelet adhesion suppressing function, and a random copolymer or an alternating copolymer is more preferred from the viewpoint of an appropriate balance between hydrophilicity and hydrophobicity in one molecule. The reason why a block copolymer, an alternating copolymer, and a random copolymer have a higher protein and platelet adhesion suppressing function than that of a graft copolymer, for example, a graft copolymer having a main chain composed of a hydrophilic monomer unit and a side chain composed of a hydrophobic monomer unit, is considered as follows. In the graft copolymer, since the monomer unit portion grafted to the main chain has many opportunities to come into contact with proteins or the like, the properties of the graft chain portion have a greater influence than the properties of the copolymerized polymer. The reason why the alternating copolymer and the random copolymer are more preferred in view of an appropriate balance between hydrophilicity and hydrophobicity than the block copolymer is considered that the properties of each monomer unit are clearly divided in the block copolymer.

The copolymer can be synthesized, for example, by a chain polymerization method typified by a radical polymerization method using an azo type initiator, but the synthesis method is not limited thereto.

The copolymer is manufactured by the following manufacturing method, but the method is not limited thereto.

Each predetermined amount of a hydrophilic monomer and a hydrophobic monomer and a polymerization solvent and a polymerization initiator are mixed under stirring at a predetermined temperature for a predetermined period of time in a nitrogen atmosphere to cause a polymerization reaction. The quantitative ratio between the hydrophilic monomer and the hydrophobic monomer can be determined according to the molar fraction of the hydrophilic monomer unit in the copolymer. The reaction liquid is cooled to room temperature to stop the polymerization reaction, and the liquid is charged into a solvent such as hexane. The deposited precipitate is collected and dried under reduced pressure to obtain a copolymer.

The reaction temperature of the polymerization reaction is preferably 30 to 150° C., more preferably 50 to 100° C., and still more preferably 70 to 80° C.

The pressure of the polymerization reaction is preferably normal pressure.

The reaction time of the polymerization reaction is appropriately selected according to conditions such as reaction temperature, and is preferably 1 hour or more, more preferably 3 hours or more, and still more preferably 5 hours or more. If the reaction time is short, a large amount of unreacted monomers may tend to remain in the copolymer. On the other hand, the reaction time is preferably 24 hours or less and more preferably 12 hours or less. If the reaction time is long, side reactions such as formation of dimers tend to occur, which may make it difficult to control the molecular weight.

The polymerization solvent used for the polymerization reaction is not particularly limited as long as it is a solvent compatible with the monomers. For example, ether-based solvents such as dioxane or tetrahydrofuran, amide-based solvents such as N,N-dimethylformamide, sulfoxide-based solvents such as dimethylsulfoxide, aromatic hydrocarbon-based solvents such as benzene or toluene, alcohol-based solvents such as methanol, ethanol, isopropyl alcohol, amyl alcohol, or hexanol, or water, or the like is/are used. From the viewpoint of toxicity, alcohol-based solvents or water is/are preferably used.

As the polymerization initiator for the polymerization reaction, for example, a photopolymerization initiator or a thermal polymerization initiator is used. A polymerization initiator that generates any of a radical, a cation or an anion may be used, but a radical polymerization initiator is suitably used from the viewpoint that it does not cause decomposition of the monomers. Examples of the radical polymerization initiator include azo type initiators such as azobisisobutyronitrile, azobisdimethylvaleronitrile, or dimethyl azobis(isobutyrate), or peroxide initiators such as hydrogen peroxide, benzoyl peroxide, di-tert-butyl peroxide, or dicumyl peroxide.

The solvent into which the polymerization reaction solution is charged after stopping of the polymerization reaction is not particularly limited as long as it is a solvent in which the copolymer precipitates. For example, hydrocarbon-based solvents such as pentane, hexane, heptane, octane, nonane, or decane, or ether-based solvents such as dimethyl ether, ethyl methyl ether, diethyl ether, or diphenyl ether are used.

The copolymer is suitably used for a separation membrane from the viewpoint that it can suppress adhesion of proteins and platelets and can maintain water permeability even when used in contact with a biological component such as blood for a long period of time.

We provide a separation membrane including the copolymer and a medical device including the copolymer.

“Separation membrane” means a membrane that selectively removes certain substances contained in a liquid to be treated such as blood or an aqueous solution by adsorption or based on the size of the substances, and examples thereof include an ultrafiltration membrane and a reverse osmosis membrane. In the separation membrane, suppression of adhesion of proteins is required, and achievement of this is preferable for a medical device incorporating the separation membrane. The copolymer is preferably introduced onto the surface of the separation membrane. The form of the separation membrane includes a flat membrane and a hollow fiber membrane, and the hollow fiber membrane means a pipe-like shaped separation membrane.

“Medical device” is mainly used in contact with a biological component such as blood or a body fluid. Specific examples of the medical device include a blood purifier, a plasma separator, an artificial organ, a blood circuit, a blood storage bag, a catheter, or a stent, and among them, a blood purifier is preferable. A blood purifier, an artificial organ, or the like is an example of a medical device using a separation membrane module. To suppress adhesion of proteins and platelets, the copolymer can prevent formation of a thrombus by being used for a medical device such as a catheter and a stent. In a medical device, the copolymer is more preferably introduced onto a surface in contact with a biological component such as blood, and in a catheter, a stent, or the like, the copolymer is preferably introduced onto a surface of a (metal) material in contact with a biological component such as mainly blood. In a blood circuit, the copolymer is preferably introduced onto an inner surface in contact with a biological component such as mainly blood in a tube and the like, constituting the circuit.

Herein, “blood purifier” refers to a medical device incorporating a separation membrane having a function of circulating blood out of the body to remove waste products and harmful substances in blood, and examples thereof include an artificial kidney module and an exotoxin adsorption column. The copolymer is preferably introduced onto a surface of a separation membrane to be incorporated.

Although there are various forms of utilization of the copolymer, for example, in a separation membrane including the copolymer, it is necessary to introduce the copolymer onto at least a part of a surface on a side in contact with a biological component such as blood among surfaces of the separation membrane. Although it is possible to prepare a separation membrane using the copolymer itself, it is more preferable to introduce the copolymer onto another material surface from the viewpoint of the strength of the separation membrane.

For example, immersing a flat membrane of polyethylene terephthalate used in an artificial blood vessel or the like in an aqueous solution of the copolymer can suppress adhesion of platelets. From the viewpoint of preventing formation of a thrombus at the membrane surface, the number of adhered platelets per an area of 4.3×10³ μm² is preferably 20 or less, more preferably 10 or less, still more preferably 5 or less, and yet more preferably 0 or less. The concentration of the aqueous solution of the copolymer is preferably 0.01 ppm or more, and more preferably 0.1 ppm or more. The number of adhered platelets is measured by the method described later.

Moreover, the copolymer as a component forming the separation membrane may be introduced onto the surface of the membrane (in particular, the inner surface which is often brought into contact with blood) to suppress the adhesion of blood components, and the separation membrane may be incorporated into a casing and used as a separation membrane module for medical use. The form of the separation membrane is preferably a hollow fiber membrane, and preferably a hollow fiber membrane module in which the hollow fiber membrane is incorporated into a casing.

“Introduce a copolymer onto a surface” means to place (coating, chemical bonding, or the like) the copolymer on a material surface by a method such as coating or immersion. For example, in a separation membrane, a method of forming a membrane and then coating a copolymer is preferable, and a method of bringing the copolymer as a solution (preferably an aqueous solution) into contact with the surface of the membrane is preferably used. More specifically, there can be mentioned a method of flowing a solution of the copolymer at a predetermined flow rate, and a method of immersing the membrane in the solution. In addition, in a method of adding a copolymer to a stock solution forming a membrane and spinning the stock solution, there is also a method of intentionally setting conditions so that the copolymer gathers on the membrane surface.

Furthermore, as a method of introducing the copolymer onto a material surface, covalent bonding by chemical reaction may be utilized. Specifically, it is achieved by reacting a reactive group on the surface of the base of the material such as an amino group, a sulfonic acid group, or a halogenated alkyl group with a reactive group introduced into a main chain terminal or a side chain of the copolymer.

Examples of the method of introducing a reactive group onto a material surface include a method of polymerizing monomers having a reactive group to obtain a base having a reactive group on the surface, and a method of introducing a reactive group by ozone treatment or plasma treatment after polymerization.

Examples of the method of introducing a reactive group into the main chain terminal of the copolymer include a method of using an initiator having a reactive group such as 2,2′-azobis [2-methyl -N-(2 -hy droxy ethyl)propionamide] or 4,4′-azobis(4 -cyanovaleric acid).

Examples of the method of introducing a reactive group into the side chain of the copolymer include a method of copolymerizing monomers having a reactive group such as glycidyl methacrylate as long as the action and function of the copolymer are not impaired.

The polymer that can serve as a material of the medical device is not particularly limited, and examples thereof include a polysulfone-based polymer, polystyrene, polyurethane, polyethylene, polypropylene, polycarbonate, polyvinylidene fluoride, polyacrylonitrile, polymethyl methacrylate, polyvinyl chloride, polyamide, polyimide, or polyester. Among them, a polysulfone-based polymer and polymethyl methacrylate are suitably used because they are easy to form a hollow fiber membrane and are easy to be coated with the polymer.

The main raw material of the hollow fiber membrane is preferably a polysulfone-based polymer. Herein, the polysulfone-based polymer is a polymer having an aromatic ring, a sulfonyl group, and an ether group in the main chain, and examples thereof include polysulfone, polyethersulfone, or polyarylethersulfone. Herein, the main raw material represents a raw material contained in an amount of 90% by weight or more based on the entire polysulfone-based polymer.

As the main raw material of the hollow fiber membrane, for example, a polysulfone-based polymer represented by chemical Formulas (III) and/or (IV) is suitably used, but the main raw material is not limited thereto. In the formulas, n is an integer of 1 or more, and preferably 50 to 80. When n has a distribution, the average value is regarded as n.

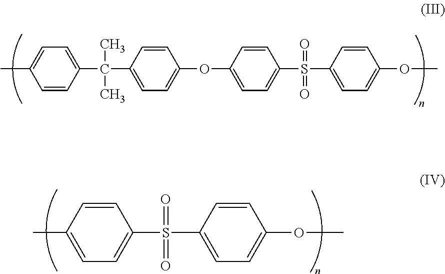

The polysulfone-based polymer that can be used in the separation membrane module for medical use is suitably a polymer composed only of the repeating units represented by Formula (III) and/or (IV), but the polysulfone-based polymer may be a copolymer with a different monomer or may be a modified product as long as the effect is not hindered. When the polysulfone-based polymer is copolymerized with a different monomer, the copolymerize ratio of the different monomer is preferably 10% by weight or less based on the entire polysulfone-based polymer.

Specific examples of the polysulfone-based polymer that can be used in the separation membrane module for medical use include polysulfone-based polymers such as Udel Polysulfone P-1700 and P-3500 (manufactured by SOLVAY), Ultrason (registered trademark) 53010 and S6010 (manufactured by BASF Corporation), VICTREX (manufactured by Sumitomo Chemical Company, Limited), Radel (registered trademark) A (manufactured by SOLVAY), and Ultrason (registered trademark) E (manufactured by BASF Corporation).

As a method of manufacturing the separation membrane module for medical use, there are various methods according to the use thereof. As one aspect thereof, the manufacturing method can be divided into a step of manufacturing a separation membrane and a step of incorporating the separation membrane into a module. Furthermore, in manufacturing the separation membrane module, a treatment by radiation irradiation may be used before the step of incorporating the separation membrane into a module, or after the step of incorporating the separation membrane into a module. Performing a treatment by irradiation with γ-rays as a treatment by radiation irradiation after the step of incorporating the separation membrane into a module is preferred in that sterilization can be performed at the same time because the separation membrane module is intended for medical use.

The separation membrane module for medical use used in a blood purifier is preferably a hollow fiber membrane module, and one example of a method of manufacturing the same will be described.

An example of a method of manufacturing a hollow fiber membrane incorporated into a blood purifier is the following method. That is, a stock solution (the concentration of polysulfone and polyvinylpyrrolidone is preferably 10 to 30% by weight, and more preferably 15 to 25% by weight) obtained by dissolving polysulfone and polyvinylpyrrolidone (the weight ratio is preferably 20:1 to 1:5, and more preferably 5:1 to 1:1) in a mixed solution of a good solvent for polysulfone (preferably N,N-dimethylacetamide, dimethylsulfoxide, N,N-dimethylformamide, N-methylpyrrolidone, or dioxane, or the like) and a poor solvent therefor (e.g., water, glycerin, or the like) is discharged from a double annular spinneret while flowing an injection solution through the inside of the spinneret, and the stock solution and the injection solution are let to travel in a dry part and then led to a coagulation bath. At this time, since the humidity of the dry part has some influence, it is also possible to accelerate the phase separation behavior near the outer surface of the membrane by moisture supply from the outer surface during traveling of the membrane in the dry part to increase the pore diameter, and consequently reduce the permeation/diffusion resistance during the dialysis. However, if the relative humidity is too high, the coagulation of the stock solution on the outer surface becomes dominant and the pore diameter rather decreases, which consequently tends to increase the permeation/diffusion resistance during the dialysis. Therefore, the relative humidity is suitably 60 to 90%. As for the composition of the injection solution, it is preferred to use a solution having a composition based on the solvent used for the stock solution from the viewpoint of process suitability. As for the concentration of the injection solution, for example, when N,N-dimethylacetamide is used as the injection solution, an aqueous solution having a concentration of 45 to 80% by weight is suitably used, and an aqueous solution having a concentration of 60 to 75% by weight is more suitably used.

Herein, the good solvent means a solvent in which a subject polymer is dissolved in an amount of 10% by weight or more at 20° C. The poor solvent means a solvent in which a subject polymer is dissolved in an amount of less than 10% by weight at 20° C.

The method of incorporating the hollow fiber membrane is not particularly limited, and the following method is exemplified. First, the hollow fiber membrane is cut into a required length, required number of the membranes are bundled, and the bundle is placed in a cylindrical case. Then, the case is temporarily capped at both ends, and a potting agent is placed at both ends of the hollow fiber membrane. In this example, a method of placing a potting agent while rotating the module with a centrifuge is preferred because the potting agent is uniformly filled. After the potting agent solidifies, both the ends of the hollow fiber membrane are cut so as to be opened to obtain a hollow fiber membrane module in which the hollow fiber membrane is incorporated into a module.

Since the polysulfone-based polymer used as a main raw material of the hollow fiber membrane is generally strongly hydrophobic, organic substances such as proteins are likely to adhere when the polymer is used as it is as a hollow fiber membrane. Therefore, in the separation membrane module for medical use, a hollow fiber membrane including the copolymer introduced onto the surface is suitably used. Examples of the method of introducing the copolymer onto the surface include a method for bringing a solution in which the copolymer is dissolved into contact with a hollow fiber membrane in the module, and a method for bringing an injection solution containing the copolymer into contact with the inside of the hollow fiber membrane during spinning of the hollow fiber membrane.

When an aqueous solution in which the copolymer is dissolved is passed through a hollow fiber membrane in a module to introduce onto the surface, a sufficient amount of the copolymer is not introduced onto the surface if the copolymer concentration of the aqueous solution is too low. Therefore, the copolymer concentration in the aqueous solution is preferably 10 ppm or more, more preferably 100 ppm or more, and most preferably 300 ppm or more. However, if the copolymer concentration in the aqueous solution is too high, there is a concern that the amount of eluate from the module will increase. Therefore, the copolymer concentration in the aqueous solution is preferably 100,000 ppm or less, more preferably 10,000 ppm or less. The number average molecular weight of the copolymer is measured by gel permeation chromatography (GPC) as mentioned later.

When the copolymer is hardly soluble or insoluble in water, the copolymer may be dissolved in an organic solvent which does not dissolve the hollow fiber, or a mixed solvent of water and an organic solvent which is compatible with water and does not dissolve the hollow fiber. Specific examples of the organic solvent or the organic solvent that can be used in the mixed solvent include, but are not limited to, alcohol-based solvents such as methanol, ethanol, or propanol.

In addition, if the ratio of the organic solvent in the mixed solvent is large, the hollow fiber swells, the copolymer diffuses into the hollow fiber membrane, and it may become difficult to introduce the copolymer efficiently only onto the surface. Therefore, the weight fraction of the organic solvent in the mixed solvent is preferably 60% or less, more preferably 10% or less, and most preferably 1% or less.

In the separation membrane module for medical use, to prevent elution of the introduced copolymer at the time of use of the module, it is preferred that the copolymer is insolubilized by radiation irradiation or heat treatment after being introduced onto the surface of the separation membrane.

For the radiation irradiation, α-rays, β-rays, γ-rays, X-rays, ultraviolet rays, or electron beams or the like can be used. For blood purifiers such as artificial kidneys, sterilization before shipping is mandatory. For the sterilization, in recent years, a radiation sterilization method using γ-rays or electron beams is often used from the viewpoint of the low residual toxicity and convenience. Therefore, use of the radiation sterilization method in a state where an aqueous solution in which the copolymer is dissolved is in contact with the hollow fiber membrane in the separation membrane module for medical use is preferred because insolubilization of the copolymer can be achieved simultaneously with sterilization.

When simultaneously performing sterilization and reforming of the hollow fiber membrane in the separation membrane module for medical use, the irradiation dose of radiation is preferably 15 kGy or more, more preferably 25 kGy or more. This is because an irradiation dose of 15 kGy or more is effective for sterilizing a blood purification module or the like with γ-rays. The irradiation dose is preferably 100 kGy or less. If the irradiation dose exceeds 100 kGy, three-dimensional crosslinking and decomposition of the ester group moiety of the vinyl carboxylate monomer unit are likely to occur in the copolymer, which may lower blood compatibility.

To suppress the crosslinking reaction upon irradiation with radiation, an antioxidant may be used. An antioxidant means a substance having a property of easily giving electrons to other molecules. Examples thereof include, but are not limited to, water-soluble vitamins such as vitamin C, polyphenols, or alcohol-based solvents such as methanol, ethanol, or propanol. These antioxidants may be used alone or two or more antioxidants may be used in combination. In the case of using the antioxidant in the separation membrane module for medical use, safety should be considered. Therefore, an antioxidant with low toxicity such as ethanol or propanol is suitably used.

When the copolymer is introduced onto the surface of the hollow fiber membrane, the amount of the copolymer introduced onto the surface of the hollow fiber membrane can be quantified by attenuated total reflection infrared spectroscopy (ATR-IR) as mentioned later. Furthermore, if necessary, the amount can be quantified also by X-ray photoelectron spectroscopy (XPS) or the like. Herein, the surface of the hollow fiber membrane means the inner surface of the hollow fiber membrane that comes into contact with blood.

When quantifying the amount of the copolymer introduced onto the surface of the separation membrane by ATR-IR, a ratio of the infrared absorption peak area (A_{C═O}) derived from the ester group C═O in the range of 1,711 to 1,751 cm⁻¹ to the infrared absorption peak area (A_{C═C}) derived from the benzene ring C═C of polysulfone in the range of 1,549 to 1,620 cm⁻¹, that is, (A_{C═O})/(A_{C═C}) is calculated at three different positions on the membrane surface. Measurement is made at arbitrary three positions in one hollow fiber membrane, the area ratio is calculated, and the average value thereof is regarded as the surface introduction amount of the copolymer. The ATR-IR is capable of measuring the surface up to several micrometers in depth.

To sufficiently suppress adhesion of proteins and platelets to the separation membrane module for medical use, the amount of the copolymer introduced onto the surface of the separation membrane is preferably 0.001 or more, more preferably 0.01 or more, and most preferably 0.03 or more. The upper limit of the surface introduction amount of the copolymer is not particularly limited, but if the surface introduction amount of the polymer is too large, the amount of the eluate may increase, and the upper limit is preferably 1.0 or less, more preferably 0.9 or less, and still more preferably 0.8 or less. Any preferable lower limit can be combined with any preferable upper limit.

Examples of the method for quantifying adhesion of proteins and platelets include a method for measuring the reduction rate of water permeability, the amount of adhered platelets, and the temporal change of the sieving coefficient of albumin when bovine blood is perfused into a separation membrane module for medical use in which the copolymer is introduced.

The reduction rate of water permeability is calculated by measuring the water permeability before and after bovine blood is perfused into a separation membrane module for medical use in which the copolymer is introduced onto the surface. Adhesion of proteins and platelets causes clogging of the pores of the hollow fibers so that the water permeability reduces. Specific procedures are as follows. First, a circuit is connected to an inlet and an outlet on a B side (blood side) of the hollow fiber membrane module, and washed with water at a rate of 200 mL/min for 5 minutes. Next, water (37° C.) is flowed at a rate of 200 mL/min, the outflow from the B outlet is adjusted, and a filtration amount V per 1 minute of outflow to a D side and an average pressure P of the B side inlet and outlet are measured. By changing outflow from the B outlet, measurement is performed at three points, and the average value of the value calculated by the following formula is regarded as water permeability [UFRP-0]: UFRP (mL/hr/mmHg/m²)=V×60/P/A
V: Filtration amount (mL/min), P: Pressure (mmHg), A: Membrane area (m²).

Next, 2 L of bovine whole blood is circulated. A hollow fiber membrane module (1) and a blood circuit are connected as shown in the drawing. Bovine blood supplemented with heparin is adjusted so that the hematocrit is 30% and the total protein concentration is 6 to 7 g/dl, and put in a circulation beaker (4). The circulation beaker (4) containing the bovine blood is kept at 37° C. in a warm water bath (9) equipped with a heater (8). An inlet of a Bi circuit (5), an outlet of a Bo circuit (6), and an outlet of an F circuit (7) are placed in the circulation beaker (4) containing 2 L of the bovine blood adjusted as mentioned above, and a Bi pump (2) is started at a circulation flow rate of 100 ml/min. After 60 minutes, the circulation is stopped. Then, the circuit is connected to an inlet and an outlet on a B side (blood side) of the hollow fiber module, and washed with physiological saline at a rate of 200 mL/min for 10 minutes. Furthermore, the circuit is washed with water at a rate of 200 mL/min for 5 minutes, and then water permeability [UFRP-60] is calculated in the same manner as mentioned above.

The reduction rate of water permeability is calculated by the following formula:

Reduction rate %=([UFRP-0]−[UFRP-60])/[UFRP−0]×100.

The reduction rate of water permeability when a separation membrane using the copolymer is used is preferably 15% or less. Furthermore, when a medical device, for example, a blood purifier, can be used for a long period of time, the reduction rate of water permeability is preferably 10% or less.

To quantify adhesion of platelets, the amount of adhered human platelets of the hollow fiber membrane is measured. A double-sided tape is attached to a circular plate 18 mmΦ in diameter made of polystyrene, and a hollow fiber membrane irradiated with γ-rays at 25 kGy is fixed thereto. The attached hollow fiber membrane is trimmed to a semi-cylindrical shape with a single-edged blade to expose the inner surface of the hollow fiber membrane. If there is any contaminant, scratch, crease or the like on the inner surface of the hollow fiber, platelets may adhere to that portion and hinder correct evaluation, and thus attention should be paid. The circular plate is attached to a cylindrically cut Falcon (registered trademark) tube (18 mmΦ in diameter, No. 2051) so that the face to which the hollow fiber membrane was attached is inside of the cylinder, and the gap is filled with Parafilm. The inside of this cylindrical tube is washed with physiological saline, and then the tube is filled with physiological saline. Human venous blood is collected, and heparin is added to the blood immediately after collection so that the concentration will be 50 U/ml. The physiological saline in the cylindrical tube is discharged, and then 1.0 ml of the blood is put in the cylindrical tube within 10 minutes after the blood collection and shaken at 37° C. for 1 hour. Then, the hollow fiber membrane is washed with 10 ml of physiological saline, and blood components are fixed with 2.5% glutaraldehyde physiological saline and washed with 20 ml of distilled water. The washed hollow fiber membrane is dried under reduced pressure at 20° C. and 0.5 Torr for 10 hours. This hollow fiber membrane is attached to a sample stage of a scanning electron microscope with a double-sided tape. After that, a Pt-Pd thin film is formed on the hollow fiber membrane surface by sputtering to prepare a sample. The inner surface of this hollow fiber membrane sample is observed with a field emission type scanning electron microscope (manufactured by Hitachi, Ltd.; S800) at a magnification of 1500 times, and the number of adhered platelets in one field of view (4.3×10³ μm²) is counted. When 50 or more platelets adhered, it is assumed that no platelet adhesion suppression effect is exerted, and the number of adhered platelets is regarded as 50. Since a pool of blood tends to occur at an end portion in the longer direction of the hollow fiber, the average value of the number of adhered platelets in 20 different fields of view near the center of the hollow fiber membrane is regarded as the number of adhered platelets (number/4.3×10³ μm²).

The number of adhered platelets of the separation membrane using the copolymer is preferably 20 or less. Furthermore, to make it possible to use a medical device, for example, a blood purifier for a long period of time, the number of adhered platelets is most preferably 0.

In blood purifiers such as artificial kidney modules, adhesion of proteins and platelets not only deteriorates fractionation performance but also inhibits blood circulation inside the hollow fibers due to blood coagulation, and extracorporeal circulation cannot be continued in some cases. The adhesion of proteins and platelets occurs particularly remarkably within 60 minutes after contact with blood. Thus, the sieving coefficients of albumin after 10 minutes and 60 minutes from the start of circulation of blood are measured, and the reduction rate is calculated.

The sieving coefficient of albumin is measured as follows. First, a hollow fiber membrane module (1) and a blood circuit are connected as shown in the drawing. Bovine blood supplemented with heparin is adjusted so that the hematocrit is 30% and the total protein concentration is 6 to 7 g/dl, and put in a circulation beaker (4). The circulation beaker (4) containing the bovine blood is kept at 37° C. in a warm water bath (9) equipped with a heater (8).

An inlet of a Bi circuit (5), an outlet of a Bo circuit (6), and an outlet of an F circuit (7) are placed in the circulation beaker (4) containing 2 L of the bovine blood adjusted as mentioned above, and a Bi pump (2) is started at a circulation flow rate of 100 ml/min.

The Bi circuit (5) represents a flow path of blood which flows out from the circulation beaker (4), flows through the Bi pump (2), and enters a blood side inlet of the hollow fiber membrane module (1). The Bo circuit (6) represents a flow path of blood which flows out from a blood side outlet of the hollow fiber membrane module (1) and enters the circulation beaker (4). The F circuit (7) represents a flow path of blood which flows out from a dialysate side outlet of the hollow fiber membrane module (1), flows through an F pump (3), and enters the circulation beaker (4). The Bi pump (2) represents a pump used for flowing blood through the Bi circuit (5).

Subsequently, the F pump (3) is started at a filtration flow rate of 10 ml/min, and the blood is sampled over time at the inlet of the Bi circuit (5), the outlet of the Bo circuit (6), and the outlet of the F circuit (7). Note that the F pump (3) represents a pump used for flowing blood through the F circuit (7).

The albumin concentration at each elapsed time from the start of the F pump (3) is measured, and the sieving coefficient of albumin (ScAlb) at each elapsed time is calculated according to the following formula:

ScAlb (%)=CF/{0.5×(CBi+CBo)}×100.

In the abovementioned formula, CF represents the albumin concentration (g/ml) at the outlet of the F circuit (7), CBo represents the albumin concentration (g/ml) at the outlet of the Bo circuit (6), and CBi represents the albumin concentration (g/ml) at the inlet of the Bi circuit (5).

The reduction rate of the sieving coefficient of albumin after a perfusion time of 60 minutes (ScAlb60) to the sieving coefficient of albumin after a perfusion time of 10 minutes (ScAlb10) is calculated according to the following formula:

Reduction rate (%)=(ScAlb10−ScAlb60)/ScAlb10×100.

In the separation membrane module for medical use in which the copolymer is introduced onto the surface, the reduction rate of the sieving coefficient of albumin after a perfusion time of 60 minutes to the sieving coefficient of albumin after a perfusion time of 10 minutes is preferably 25% or less to keep using a separation membrane for 4 hours. Furthermore, to keep using a medical device, for example, a blood purifier for 24 hours, the reduction rate is more preferably 10% or less. Furthermore, to make it possible to use a blood purifier for 48 hours or more, the reduction rate of the sieving coefficient of albumin is still more preferably 5% or less.

To suppress adhesion of platelets and proteins when using as a separation membrane, it is preferable that the reduction rate of water permeability is 15% or less, the number of adhered platelets is 5 or less, and the reduction rate of the sieving coefficient of albumin is 25% or less. Furthermore, to suppress adhesion of proteins and platelets for a long period of time, it is more preferable that the reduction rate of water permeability is 10% or less, the number of adhered platelets is 0 or less, and the reduction rate of the sieving coefficient of albumin is 5% or less.

In a thrombus formation test on a PET filter, the PET filter was cut into a 1 cm×1 cm piece, and placed in a cylindrical container made of polypropylene with a diameter of 1 cm and a depth of 0.8 cm. To this, 1 ml of human blood supplemented with heparin so that the concentration became 50 U/ml was added so that the filter was immersed, and then shaken for 30 minutes. The filter was taken out, and whether a thrombus was formed or not was confirmed. This procedure enables simple evaluation of whether the medical device can maintain antithrombogenicity and can be used for a long period of time.

Since the copolymer can maintain the property of suppressing adhesion of platelets and proteins for a long period of time, it is suitably used in particularly medical devices. In particular, the copolymer is suitably used in a blood purifier, particularly a continuous blood purifier.

### EXAMPLES

Our copolymers, membranes, devices and purifiers will be described by way of Examples, but this disclosure is not limited to the Examples.

In Examples and Comparative Examples, the following abbreviations are used:

PVP: Polyvinylpyrrolidone

PVAc: Polyvinyl acetate

PNVA/PtVA: N-vinylacetamide/vinyl pivalate random copolymer

PNIPAM/PEPR: N-isopropylacrylamide/ethyl acrylate random copolymer

PVP/PVAc: Vinylpyrrolidone/vinyl acetate random copolymer

PVP/PVPr: Vinylpyrrolidone/vinyl propionate random copolymer

PVP/PtVA: Vinylpyrrolidone/vinyl pivalate random copolymer

PVP/PVBu: Vinylpyrrolidone/vinyl butyrate random copolymer

PVP/PVBa: Vinylpyrrolidone/vinyl benzoate random copolymer

PVP/PVDe: Vinylpyrrolidone/vinyl decanoate random copolymer

PVP/PVNo: Vinylpyrrolidone/vinyl nonanoate random copolymer

PVP/PVP6: Vinylpyrrolidone /1-vinyl-2-piperidone random copolymer

ACMO/PVP: Acryloylmorpholine/vinylpyrrolidone random copolymer

PVCL/PS: Vinyl caprolactam/polystyrene random copolymer.

### Evaluation Method

(1) Hydration Energy Density of Copolymer

The hydration energy of the monomer unit obtained from quantum chemical calculation is defined by the molecular model of the monomer unit shown below.

With respect to the molecular model of the monomer unit, when the repeating unit is a structure shown by chemical formula (V), a structure shown by chemical formula (VI) was included in calculation. As an example, the case of vinyl propionate was described.

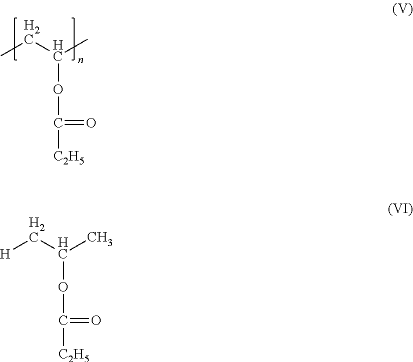

Gaussian09, Revision D.01 (registered trademark) manufactured by Gaussian, Inc. was used for quantum chemical calculation, and MaterialsStudio (registered trademark) manufactured by BIOVIA Corp. was used for Connollysurface.

The hydration energy of the monomer unit was calculated by the following method.

First, the structure of the monomer unit in vacuum was optimized, and then energy in vacuum and energy in water were calculated for the optimized structure.

In the structure optimization step, density functional theory was used. B3LYP was used for the functional, and 6-31G(d,p) was used for the basis function. In addition, opt was set as a keyword entered in an input file.

The energy in vacuum was calculated using density functional theory. B3LYP was used for the functional, and 6-31G(d,p) was used for the basis function.

The energy in water was calculated using density functional theory. B3LYP was used for the functional, and 6-31G(d,p) was used for the basis function. In addition, a polarizable continuum model was used for calculation of energy in water, and the following parameters were used as keywords:
SCRF=(PCM, G03Defaults, Read, Solvent=Water)
Radii=UAHF
Alpha=1.20.
The volume of the monomer unit was calculated using the Connollysurface method. In that case, the parameters set were as follows:
Gridresolution=Coarse
Gridinterval=0.75 Å (0.075 nm)
vdWfactor=1.0
Connollyradius=1.0 Å (0.1 nm).

The hydration energy density of the copolymer is defined by Formula (1) based on the hydration energy and the volume calculated by the Connollysurface method. The volume of the monomer unit in Formula (1) was the optimized structure.
(2) Hydration Energy Density of Monomer Unit i

The hydration energy density of monomer unit i was calculated based on Formula (2).
(3) Volume fraction of monomer unit with highest hydration energy density of monomer unit i

The volume fraction of a monomer unit with a highest hydration energy density of monomer unit i was calculated based on Formula (3).
(4) Difference in Hydration Energy Density

The difference in hydration energy density was calculated based on Formula (4).

The hydration energy density of the copolymer, the presence or absence of a hydroxy group, the volume fraction of a monomer unit with a highest hydration energy density of monomer unit i, and the difference in hydration energy density calculated in the following Examples and Comparative Examples are shown in Table 1.

TABLE 1

| | | | Difference in | |
|---|---|---|---|---|
| | | Hydration energy | hydration energy | Presence or |
| | Name of | density of copolymer | density | absence of |
| | polymer | (kJ · mol⁻¹ · nm⁻³ ) | (kJ · mol⁻¹ · nm⁻³ ) | hydroxy group |
| Example 1 | PVP/PVPr | 182.422 | 82.006 | C |
| | (molar ratio | | | |
| | 60:40) | | | |
| Example 2 | PVP/PtVA | 171.962 | 124.265 | C |
| | (molar ratio | | | |
| | 70:30) | | | |
| Example 3 | PVP/PVPr | 190.372 | 82.006 | C |
| | (molar ratio | | | |
| | 70:30) | | | |
| Example 4 | PVP/PVBu | 193.301 | 96.232 | C |
| | (molar ratio | | | |
| | 80:20) | | | |
| Example 5 | PVP/PVBa | 189.535 | 102.926 | C |
| | (molar ratio | | | |
| | 80:20) | | | |
| Example 6 | PVP/PVDe | 167.778 | 143.930 | C |
| | (molar ratio | | | |
| | 80:20) | | | |
| Example 7 | PVP/PVNo | 171.126 | 140.164 | C |
| | (molar ratio | | | |
| | 80:20) | | | |
| Example 8 | PVP/PVPr | 165.686 | 82.006 | C |
| | (molar ratio | | | |
| | 40:60) | | | |
| Example 9 | PNVA/PtVA | 177.820 | 215.894 | C |
| | (molar ratio | | | |
| | 50:50) | | | |
| Example 10 | PNIPAM/PEPR | 180.749 | 91.211 | C |
| | (molar ratio | | | |
| | 50:50) | | | |
| Comparative | PVP | 213.384 | — | C |
| Example 1 | | | | |
| Comparative | PVAc | 152.716 | — | C |
| Example 2 | | | | |
| Comparative | PVP/PVAc | 189.117 | 60.668 | C |
| Example 3 | (weight ratio | | | |
| | 60:40) | | | |
| Comparative | PVP/PVP6 | 194.974 | 42.677 | C |
| Example 4 | (molar ratio | | | |
| | 60:40) | | | |
| Comparative | ACMO/PVP | 222.589 | 131.378 | C |
| Example 5 | (molar ratio | | | |
| | 60:40) | | | |
| Comparative | PVCL/PS | 141.419 | 76.567 | C |
| Example 6 | (molar ratio | | | |
| | 60:40) | | | |
| Comparative | PVP/PVPr | 157.318 | 82.006 | C |
| Example 7 | (molar ratio | | | |
| | 30:70) | | | |

| | Volume fraction of | | | | |
|---|---|---|---|---|---|
| | monomer unit with | | | | |
| | highest hydration | | Reduction rate of | | Reduction rate of |
| | energy density of | Comprehensive | water permeability | Amount of adhered | sieving coefficient |
| | monomer unit i (%) | evaluation | (%) | platelets (number) | of albumin (%) |
| Example 1 | 62.2 | A | 7 | 0 | 2 |
| Example 2 | 66.6 | A | 9 | 0 | 3 |
| Example 3 | 71.9 | B | 13 | 0 | 7 |
| Example 4 | 79.4 | B | 8 | 0 | 9 |
| Example 5 | 76.9 | B | 5 | 4 | 8 |
| Example 6 | 68.4 | B | 3 | 2 | 17 |
| Example 7 | 69.8 | B | 10 | 1 | 25 |
| Example 8 | 42.3 | B | 12 | 2 | 8 |
| Example 9 | 41.2 | A | 6 | 0 | 2 |
| Example 10 | 56.0 | A | 7 | 0 | 2 |
| Comparative | 100.0 | C | 55 | 21 | 60 |
| Example 1 | | | | | |
| Comparative | 100.0 | C | 35 | 21 | 29 |
| Example 2 | | | | | |
| Comparative | 59.9 | C | 32 | 2 | 15 |
| Example 3 | | | | | |
| Comparative | 57.5 | C | 28 | 18 | 26 |
| Example 4 | | | | | |
| Comparative | 63.9 | C | 34 | 40 | 45 |
| Example 5 | | | | | |
| Comparative | 66.5 | C | 28 | 46 | 39 |
| Example 6 | | | | | |
| Comparative | 32.0 | C | 27 | 4 | 10 |
| Example 7 | | | | | |

In Table 1, as a comprehensive evaluation, the example where the reduction rate of water permeability is 15% or less, the number of adhered platelets is 5 or less, and the reduction rate of the sieving coefficient of albumin is 25% or less was evaluated as B. Furthermore, the example where the reduction rate of water permeability is 10% or less, the number of adhered platelets is 0 or less, and the reduction rate of the sieving coefficient of albumin is 5% or less was evaluated as A. The other examples were evaluated as C. The example of a monomer unit containing a hydroxy group was evaluated as B, and the example of a monomer unit not containing a hydroxy group was evaluated as C.
(5) Number Average Molecular Weight

A 0.1 N LiNO₃ solution of water/methanol=50/50 (volume ratio) was prepared and used as a GPC developing solution. In 2 ml of the solution, 2 mg of a copolymer was dissolved. Into a Prominence GPC system manufactured by Shimadzu Corporation, 100 μL of this copolymer solution was injected, and measurement was performed. The configuration of the apparatus is as follows:

pump: LC-20AD, auto sampler: SIL-20AHT, column oven: CTO-20A, detector: RID-10A, column: manufactured by Tosoh Corporation; GMPW_{XL} (inner diameter 7.8 mm×30 cm, particle size 13 μm). The flow rate was 0.5 mL/min, and the measurement time was 30 minutes. The detection was performed with a differential refractive index detector RID-10A (manufactured by Shimadzu Corporation), and the number average molecular weight was calculated from the peak derived from the copolymer that appeared around the elution time of 15 minutes. The number average molecular weight was calculated by rounding off the number to the nearest hundred. A polyethylene oxide standard sample (0.1 kD to 1258 kD) manufactured by Agilent was used to prepare a calibration curve.
(6) Molar Fraction of Hydrophilic Monomer Unit

In 2 ml of chloroform-D, 99.7% (manufactured by Wako Pure Chemical Industries, Ltd.; containing 0.05 V/V% TMS), 2 mg of the copolymer was dissolved, and the solution was put in an NMR sample tube and subjected to NMR (manufactured by JEOL Ltd.; superconducting FTNMREX-270) measurement. The temperature was set to room temperature, and the integration time was 32 times. From this measurement result, using the area of the region surrounded by the peak derived from the proton (3H) bonded to the carbon atom adjacent to the nitrogen atom of vinylpyrrolidone observed between 2.7 to 4.3 ppm and the baseline: 3A_{PVP}, and the area of the region surrounded by the peak derived from the proton (1H) bonded to the carbon at the a-position of vinyl carboxylate observed between 4.3 to 5.2 ppm and the baseline: A_{VC}, the value of A_{PVP}/(A_{PVP}+A_{VC})×100 was calculated and regarded as the molar fraction of the vinylpyrrolidone unit. This method is an example of measuring the molar fraction in a copolymer vinylpyrrolidone and vinyl carboxylate. In the example of a copolymer made of a combination of other monomers, peaks derived from appropriate protons are selected for the determination of the molar fraction. The molar fraction was calculated by rounding off the number to the nearest ten.
(7) Measurement of Reduction Rate of Water Permeability Before and After Circulation of Bovine Blood

First, a circuit was connected to an inlet and an outlet on a B side (blood side) of the hollow fiber module, and washed with water at a rate of 200 mL/min for 5 minutes. Next, water (37° C.) was flowed at a rate of 200 mL/min, the outflow from the B outlet was adjusted, and a filtration amount V per 1 minute of outflow to a D side and an average pressure P of the B side inlet and outlet were measured. By changing outflow from the B outlet, measurement was performed at three points, and the average value of the value calculated by the following formula was regarded as water permeability 0 minutes after start of circulation [UFRP-0]: UFRP (mL/hr/mmHg/m²)=V×60/P/A
V: Filtration amount(mL/min), P: Pressure (mmHg), A: Membrane area (m²).

Next, 2 L of bovine whole blood was circulated. A hollow fiber membrane module (1) and a blood circuit were connected as shown in the drawing. Bovine blood supplemented with heparin was adjusted so that the hematocrit was 30% and the total protein concentration was 6 to 7 g/dl, and put in a circulation beaker (4). The circulation beaker (4) containing the bovine blood was kept at 37° C. in a warm water bath (9) equipped with a heater (8). An inlet of a Bi circuit (5), an outlet of a Bo circuit (6), and an outlet of an F circuit (7) were placed in the circulation beaker (4) containing 2 L of the bovine blood adjusted as mentioned above, and a Bi pump (2) was started at a circulation flow rate of 100 ml/min. After 60 minutes, the circulation was stopped. Then, the circuit was connected to an inlet and an outlet on a B side (blood side) of the hollow fiber module, and washed with physiological saline at a rate of 200 mL/min for 10 minutes. Furthermore, the circuit was washed with water at a rate of 200 mL/min for 5 minutes, and then water permeability 60 minutes after start of circulation [UFRP-60] was calculated in the same manner as mentioned above.

The reduction rate of water permeability was calculated by the following formula:

Reduction rate of water permeability (%)=([UFRP-0]−[UFRP-60])/[UFRP-0]×100.
(8) Method for Human Platelet Adhesion Test of Hollow Fiber Membrane

A double-sided tape was attached to a circular plate 18 mmΦ in diameter made of polystyrene, and a hollow fiber membrane irradiated with γ-rays at 25 kGy was fixed thereto. The attached hollow fiber membrane was trimmed to a semi-cylindrical shape with a single-edged blade to expose the inner surface of the hollow fiber membrane. If there is any contaminant, scratch, crease or the like on the inner surface of the hollow fiber, platelets may adhere to that portion and hinder correct evaluation, and thus attention should be paid. The circular plate was attached to a cylindrically cut Falcon (registered trademark) tube (18 mmΦ in diameter, No. 2051) so that the face to which the hollow fiber membrane was attached was inside of the cylinder, and the gap was filled with Parafilm. The inside of this cylindrical tube was washed with physiological saline, and then the tube was filled with physiological saline. Human venous blood was collected, and heparin was added to the blood immediately after collection so that the concentration would be 50 U/ml. The physiological saline in the cylindrical tube was discharged, and then 1.0 ml of the blood was put in the cylindrical tube within 10 minutes after the blood collection and shaken at 37° C. for 1 hour. Then, the hollow fiber membrane was washed with 10 ml of physiological saline, and blood components were fixed with 2.5% glutaraldehyde physiological saline and washed with 20 ml of distilled water. The washed hollow fiber membrane was dried under reduced pressure at 20° C. and 0.5 Torr for 10 hours. This hollow fiber membrane was attached to a sample stage of a scanning electron microscope with a double-sided tape. After that, a Pt-Pd thin film was formed on the hollow fiber membrane surface by sputtering to prepare a sample. The inner surface of this hollow fiber membrane sample was observed with a field emission type scanning electron microscope (manufactured by Hitachi, Ltd.; S800) at a magnification of 1500 times, and the number of adhered platelets in one field of view (4.3×10³ μm²) was counted. When 50 or more platelets adhered, it was assumed that no platelet adhesion suppression effect was exerted, and the number of adhered platelets was regarded as 50. Since a pool of blood tends to occur at an end portion in the longer direction of the hollow fiber, the average value of the number of adhered platelets in 20 different fields of view near the center of the hollow fiber membrane was regarded as the number of adhered platelets (number/4.3×10³ μm²).
(9) Reduction Rate of Sieving Coefficient of Albumin

The sieving coefficient of albumin was measured as follows. First, a hollow fiber membrane module (1) and a blood circuit were connected as shown in the drawing. Bovine blood supplemented with heparin was adjusted so that the hematocrit was 30% and the total protein concentration was 6 to 7 g/dl, and put in a circulation beaker (4). The circulation beaker (4) containing the bovine blood was kept at 37° C. in a warm water bath (9) equipped with a heater (8).

An inlet of a Bi circuit (5), an outlet of a Bo circuit (6), and an outlet of an F circuit (7) were placed in the circulation beaker (4) containing 2 L of the bovine blood adjusted as mentioned above, and a Bi pump (2) was started at a circulation flow rate of 100 ml/min.

Subsequently, the F pump (3) was started at a filtration flow rate of 10 ml/min, and the blood was sampled over time at the inlet of the Bi circuit (5), the outlet of the Bo circuit (6), and the outlet of the F circuit (7).

The albumin concentration at each elapsed time from the start of the F pump (3) was measured, and the sieving coefficient of albumin (ScAlb) at each elapsed time was calculated according to the following formula:

ScAlb (%)=CF/{0.5×(CBi+CBo)}×100

wherein, CF represents the albumin concentration (g/ml) at the outlet of the F circuit (7), CBo represents the albumin concentration (g/ml) at the outlet of the Bo circuit (6), and CBi represents the albumin concentration (g/ml) at the inlet of the Bi circuit (5).

The reduction rate of the sieving coefficient of albumin after a perfusion time of 60 minutes (ScAlb60) to the sieving coefficient of albumin after a perfusion time of 10 minutes (ScAlb10) was calculated according to the following formula. The reduction rate was calculated by rounding off the number to the nearest whole number.

Reduction rate (%)=(ScAlb10-ScAlb60)/ScAlb10×100
(10) Method for Thrombus Formation Test on PET Filter

A PET filter was cut into a 1 cm×1 cm piece, and placed in a cylindrical container made of polypropylene with a diameter of 1 cm and a depth of 0.8 cm. To this, 1 ml of human blood supplemented with heparin so that the concentration became 50 U/ml was added so that the filter was immersed, and then shaken for 30 minutes. The filter was taken out, and whether a thrombus was formed or not was confirmed. Method of manufacturing hollow fiber membrane module

To 72 parts by weight of N,N-dimethylacetamide and 1 part by weight of water, 18 parts by weight of polysulfone (manufactured by Teijin Amoco; Udel P-3500) and 9 parts by weight of polyvinylpyrrolidone (manufactured by BASF Corporation; K30) were added, and the mixture was heated at 90° C. for 14 hours for dissolution. This membrane-forming stock solution was discharged from an orifice-type double cylindrical spinneret having an outer diameter of 0.3 mm and an inner diameter of 0.2 mm, and an solution of 57.5 parts by weight of N,N-dimethylacetamide and 42.5 parts by weight of water was discharged as a core liquid, the membrane-forming stock solution and the core liquid were passed through a dry part having a length of 350 mm, and led to a coagulation bath of 100% water to obtain a hollow fiber. The hollow fiber thus obtained had an inner diameter of 200 μm and a membrane thickness of 40 μm. Through a plastic tube, 50 hollow fibers were passed, and a plastic tube minimodule having an effective length of 100 mm whose both ends were fixed by an adhesive was prepared. An aqueous solution in which the polymer was dissolved was passed from the blood side inlet to the dialysate side inlet of the minimodule. Furthermore, a 0.1% by weight aqueous ethanol solution was passed from the blood side inlet to the dialysate side inlet of the hollow fiber membrane module and from the blood side inlet to the blood side outlet thereof, and the module was irradiated with 25 kGy γ-rays to prepare a hollow fiber membrane module.

### Method of Manufacturing PET Filter

A polyethylene terephthalate filter (manufactured by Toray Industries, Inc.) having a membrane thickness of 5 μm was cut into a 5 cm² piece and placed in a 15 mL centrifuge tube (manufactured by AS ONE Corporation). The interior of the centrifuge tube was filled with an aqueous copolymer solution having a concentration of 0.1 ppm, the tube was covered, and the filter was irradiated with 25 kGy γ-rays to obtain a PET filter.

### EXAMPLE 1

A vinylpyrrolidone/vinyl propionate random copolymer was prepared by the following method. That is, 19.5 g of a vinylpyrrolidone monomer, 17.5 g of a vinyl propionate monomer, 56 g of t-amyl alcohol as a polymerization solvent, and 0.175 g of 2,2′-azobis(2,4-dimethylvaleronitrile) as a polymerization initiator were mixed, and the mixture was stirred at 70° C. for 6 hours in a nitrogen atmosphere. The reaction liquid was cooled to room temperature to stop the reaction, concentrated, and then charged into hexane. The deposited white precipitate was collected and dried under reduced pressure to obtain 21.0 g of a copolymer. From the result of ¹H-NMR, it was found that the molar fraction of the vinylpyrrolidone monomer unit was 60%. Furthermore, from the measurement result of GPC, the number average molecular weight was 16,500.

A separation membrane module for medical use having a shape of a hollow fiber membrane in which the prepared vinylpyrrolidone/vinyl propionate random copolymer was introduced onto the surface of the polysulfone hollow fiber was prepared by the following method. A 1.0% by weight aqueous ethanol solution in which 300 ppm of the copolymer was dissolved was passed from the blood side inlet to the dialysate side inlet of the hollow fiber membrane module prepared by the method for manufacturing a hollow fiber membrane module. Furthermore, a 0.1% by weight aqueous ethanol solution was passed from the blood side inlet to the dialysate side inlet of the hollow fiber membrane module and from the blood side inlet to the blood side outlet thereof, and the module was irradiated with 25 kGy γ-rays to prepare a separation membrane module for medical use. From the measurement result of ATR-IR, we found that the introduction amount (area ratio) of the copolymer on the inner surface of the hollow fiber was 0.06 on average. The reduction rate of water permeability of the prepared separation membrane module for medical use, the amount of adhered platelets of the hollow fiber membrane, and the sieving coefficient of albumin of the separation membrane module for medical use were measured. As a result, as shown in Table 1, the reduction rate of water permeability was 7%, the amount of adhered platelets was 0, and the reduction rate of the sieving coefficient of albumin after a perfusion time of 60 minutes to the sieving coefficient of albumin after a perfusion time of 10 minutes was 2%.

### EXAMPLE 2

A separation membrane module for medical use was prepared in the same manner as in Example 1 except that a vinylpyrrolidone/vinyl pivalate random copolymer (molar fraction of vinylpyrrolidone monomer unit: 70%, number average molecular weight: 3,900) was used in place of the vinylpyrrolidone/vinyl propionate random copolymer, and the reduction rate of water permeability, the amount of adhered platelets, and the sieving coefficient of albumin were measured. As a result, as shown in Table 1, the reduction rate of water permeability was 9%, the amount of adhered platelets was 0, and the reduction rate of the sieving coefficient of albumin after a perfusion time of 60 minutes to the sieving coefficient of albumin after a perfusion time of 10 minutes was 3%.

### EXAMPLE 3

A separation membrane module for medical use was prepared in the same manner as in Example 1 except that a vinylpyrrolidone/vinyl propionate random copolymer (molar fraction of vinylpyrrolidone monomer unit: 70%, number average molecular weight: 20,800) was used, and the reduction rate of water permeability, the amount of adhered platelets, and the sieving coefficient of albumin were measured. As a result, as shown in Table 1, the reduction rate of water permeability was 13%, the amount of adhered platelets was 0, and the reduction rate of the sieving coefficient of albumin after a perfusion time of 60 minutes to the sieving coefficient of albumin after a perfusion time of 10 minutes was 7%.

### EXAMPLE 4

A separation membrane module for medical use was prepared in the same manner as in Example 1 except that a vinylpyrrolidone/vinyl butyrate random copolymer (molar fraction of vinylpyrrolidone monomer unit: 80%, number average molecular weight: 2,100) was used in place of the vinylpyrrolidone/vinyl propionate random copolymer, and the reduction rate of water permeability, the amount of adhered platelets, and the sieving coefficient of albumin were measured. As a result, as shown in Table 1, the reduction rate of water permeability was 8%, the amount of adhered platelets was 0, and the reduction rate of the sieving coefficient of albumin after a perfusion time of 60 minutes to the sieving coefficient of albumin after a perfusion time of 10 minutes was 9%.

### EXAMPLE 5

A separation membrane module for medical use was prepared in the same manner as in Example 1 except that a copolymer as a vinylpyrrolidone/vinyl benzoate random copolymer (molar fraction of vinylpyrrolidone monomer unit: 80%, number average molecular weight: 2,900) was used in place of the vinylpyrrolidone/vinyl propionate random copolymer, and the reduction rate of water permeability, the amount of adhered platelets, and the sieving coefficient of albumin were measured. As a result, as shown in Table 1, the reduction rate of water permeability was 5%, the amount of adhered platelets was 4, and the reduction rate of the sieving coefficient of albumin after a perfusion time of 60 minutes to the sieving coefficient of albumin after a perfusion time of 10 minutes was 8%.

### EXAMPLE 6

A separation membrane module for medical use was prepared in the same manner as in Example 1, except that a vinylpyrrolidone/vinyl decanoate random copolymer (molar fraction of vinylpyrrolidone monomer unit: 80%, number average molecular weight: 19,000) was used in place of the vinylpyrrolidone/vinyl propionate random copolymer, and the reduction rate of water permeability, the amount of adhered platelets, and the sieving coefficient of albumin were measured. As a result, as shown in Table 1, the reduction rate of water permeability was 3%, the amount of adhered platelets was 2, and the reduction rate of the sieving coefficient of albumin after a perfusion time of 60 minutes to the sieving coefficient of albumin after a perfusion time of 10 minutes was 17%.

### EXAMPLE 7

A separation membrane module for medical use was prepared in the same manner as in Example 1, except that a vinylpyrrolidone/vinyl nonanoate random copolymer (molar fraction of vinylpyrrolidone monomer unit: 80%, number average molecular weight: 4,400) was used in place of the vinylpyrrolidone/vinyl propionate random copolymer, and the reduction rate of water permeability, the amount of adhered platelets, and the sieving coefficient of albumin were measured. As a result, as shown in Table 1, the reduction rate of water permeability was 10%, the amount of adhered platelets was 1, and the reduction rate of the sieving coefficient of albumin after a perfusion time of 60 minutes to the sieving coefficient of albumin after a perfusion time of 10 minutes was 25%.

### EXAMPLE 8

A separation membrane module for medical use was prepared in the same manner as in Example 1, except that, among vinylpyrrolidone/vinyl propionate random copolymers, one having a molar fraction of vinylpyrrolidone of 40% and a number average molecular weight of 20,800 was used, and the reduction rate of water permeability, the amount of adhered platelets, and the sieving coefficient of albumin were measured. As a result, as shown in Table 1, the reduction rate of water permeability was 12%, the amount of adhered platelets was 2, and the reduction rate of the sieving coefficient of albumin after a perfusion time of 60 minutes to the sieving coefficient of albumin after a perfusion time of 10 minutes was 8%.

### EXAMPLE 9

A separation membrane module for medical use having a shape of a hollow fiber membrane in which an N-vinylacetamide/vinyl pivalate random copolymer (molar fraction of N-vinylacetamide unit: 50%, number average molecular weight: 7,700) was introduced onto the surface of the polysulfone hollow fiber was prepared by the following method. A 10% by weight aqueous ethanol solution in which 100 ppm of the copolymer was dissolved was passed from the blood side inlet to the dialysate side inlet of the hollow fiber membrane module prepared by the method of manufacturing a hollow fiber membrane module. Furthermore, a 0.1% by weight aqueous ethanol solution was passed from the blood side inlet to the dialysate side inlet of the hollow fiber membrane module and from the blood side inlet to the blood side outlet thereof, and the module was irradiated with 25 kGy γ-rays to prepare a separation membrane module for medical use. From the measurement result of ATR-IR, we found that the introduction amount (area ratio) of the copolymer on the inner surface of the hollow fiber was 0.06 on average. The reduction rate of water permeability of the prepared separation membrane module for medical use, the amount of adhered platelets of the hollow fiber membrane, and the sieving coefficient of albumin of the separation membrane module for medical use were measured. As a result, as shown in Table 1, the reduction rate of water permeability was 6%, the amount of adhered platelets was 0, and the reduction rate of the sieving coefficient of albumin after a perfusion time of 60 minutes to the sieving coefficient of albumin after a perfusion time of 10 minutes was 2%.

### EXAMPLE 10

A separation membrane module for medical use having a shape of a hollow fiber membrane in which an N-isopropylacrylamide/ethyl acrylate random copolymer (molar fraction of N-isopropylacrylamide unit: 50%, number average molecular weight: 3,000) was introduced onto the surface of the polysulfone hollow fiber was prepared by the following method. A 1.0% by weight aqueous ethanol solution in which 100 ppm of the copolymer was dissolved was passed from the blood side inlet to the dialysate side inlet of the hollow fiber membrane module prepared by the method of manufacturing a hollow fiber membrane module. Furthermore, a 0.1% by weight aqueous ethanol solution was passed from the blood side inlet to the dialysate side inlet of the hollow fiber membrane module and from the blood side inlet to the blood side outlet thereof, and the module was irradiated with 25 kGy γ-rays to prepare a separation membrane module for medical use. From the measurement result of ATR-IR, we found that the introduction amount (area ratio) of the copolymer on the inner surface of the hollow fiber was 0.05 on average. The reduction rate of water permeability of the prepared separation membrane module for medical use, the amount of adhered platelets of the hollow fiber membrane, and the sieving coefficient of albumin of the separation membrane module for medical use were measured. As a result, as shown in Table 1, the reduction rate of water permeability was 7%, the amount of adhered platelets was 0, and the reduction rate of the sieving coefficient of albumin after a perfusion time of 60 minutes to the sieving coefficient of albumin after a perfusion time of 10 minutes was 2%.

### COMPARATIVE EXAMPLE 1

A separation membrane module for medical use was prepared in the same manner as in Example 1, except that polyvinylpyrrolidone (manufactured by BASF Corporation; K90) was used in place of the vinylpyrrolidone/vinyl propionate random copolymer, and the reduction rate of water permeability, the amount of adhered platelets, and the sieving coefficient of albumin were measured. As a result, as shown in Table 1, the reduction rate of water permeability was 55%, the amount of adhered platelets was 21, and the reduction rate of the sieving coefficient of albumin after a perfusion time of 60 minutes to the sieving coefficient of albumin after a perfusion time of 10 minutes was 60%.

### COMPARATIVE EXAMPLE 2

A separation membrane module for medical use was prepared in the same manner as in Example 1, except that polyvinyl acetate (manufactured by BASF Corporation; K90) was used in place of the vinylpyrrolidone/vinyl propionate random copolymer, and the reduction rate of water permeability, the amount of adhered platelets, and the sieving coefficient of albumin were measured. As a result, as shown in Table 1, the reduction rate of water permeability was 35%, the amount of adhered platelets was 21, and the reduction rate of the sieving coefficient of albumin after a perfusion time of 60 minutes to the sieving coefficient of albumin after a perfusion time of 10 minutes was 29%.

### COMPARATIVE EXAMPLE 3

A separation membrane module for medical use was prepared in the same manner as in Example 1, except that a vinylpyrrolidone/vinyl acetate random copolymer (manufactured by BASF Corporation; Kollidon VA64) was used in place of the vinylpyrrolidone/vinyl propionate random copolymer, and the sieving coefficient of albumin was measured. As a result, as shown in Table 1, the reduction rate of water permeability was 32%, the amount of adhered platelets was 2, and the reduction rate of the sieving coefficient of albumin after a perfusion time of 60 minutes to the sieving coefficient of albumin after a perfusion time of 10 minutes was 15%.

### COMPARATIVE EXAMPLE 4

A separation membrane module for medical use was prepared in the same manner as in Example 1, except that a vinylpyrrolidone/1-vinyl-2-piperidone copolymer (molar fraction of vinylpyrrolidone monomer unit: 60%, number average molecular weight: 5,100) was used in place of the vinylpyrrolidone/vinyl propionate random copolymer, and the reduction rate of water permeability, the amount of adhered platelets, and the sieving coefficient of albumin were measured. As a result, as shown in Table 1, the reduction rate of water permeability was 28%, the amount of adhered platelets was 18, and the reduction rate of the sieving coefficient of albumin after a perfusion time of 60 minutes to the sieving coefficient of albumin after a perfusion time of 10 minutes was 26%.

### COMPARATIVE EXAMPLE 5

A separation membrane module for medical use was prepared in the same manner as in Example 1, except that an acryloylmorpholine/vinylpyrrolidone random copolymer (molar fraction of acryloylmorpholine: 60%, number average molecular weight: 6,200) was used in place of the vinylpyrrolidone/vinyl propionate random copolymer, and the reduction rate of water permeability, the amount of adhered platelets, and the sieving coefficient of albumin were measured. As a result, as shown in Table 1, the reduction rate of water permeability was 34%, the amount of adhered platelets was 40, and the reduction rate of the sieving coefficient of albumin after a perfusion time of 60 minutes to the sieving coefficient of albumin after a perfusion time of 10 minutes was 45%.

### COMPARATIVE EXAMPLE6

A separation membrane module for medical use was prepared in the same manner as in Example 1, except that a vinyl caprolactam/polystyrene random copolymer (molar fraction of vinyl caprolactam monomer unit: 60%, number average molecular weight: 7,300) was used in place of the vinylpyrrolidone/vinyl propionate random copolymer, and the reduction rate of water permeability, the amount of adhered platelets, and the sieving coefficient of albumin were measured. As a result, as shown in Table 1, the reduction rate of water permeability was 28%, the amount of adhered platelets was 46, and the reduction rate of the sieving coefficient of albumin after a perfusion time of 60 minutes to the sieving coefficient of albumin after a perfusion time of 10 minutes was 39%.

### COMPARATIVE EXAMPLE 7

A separation membrane module for medical use was prepared in the same manner as in Example 1, except that, among vinylpyrrolidone/vinyl propionate random copolymers, one having a molar fraction of vinylpyrrolidone of 30% and a number average molecular weight of 10,800 was used, and the reduction rate of water permeability, the amount of adhered platelets, and the sieving coefficient of albumin were measured. As a result, as shown in Table 1, the reduction rate of water permeability was 27%, the amount of adhered platelets was 4, and the reduction rate of the sieving coefficient of albumin after a perfusion time of 60 minutes to the sieving coefficient of albumin after a perfusion time of 10 minutes was 10%.

### EXAMPLE 11

Using a vinylpyrrolidone/vinyl propionate random copolymer (molar fraction of vinylpyrrolidone monomer unit: 60%, number average molecular weight: 16,500) as the copolymer, a PET filter was prepared by the method of manufacturing a PET filter. A thrombus formation test of the PET filter thus obtained showed that no thrombus was formed as shown in Table 2.

### EXAMPLE 12

Using a vinylpyrrolidone/vinyl pivalate random copolymer (molar fraction of vinylpyrrolidone monomer unit: 70%, number average molecular weight: 3,900) as the copolymer, a PET filter was prepared by the method of manufacturing a PET filter. A thrombus formation test of the PET filter thus obtained showed that no thrombus was formed as shown in Table 2.

### EXAMPLE 13

Using a vinylpyrrolidone/vinyl butyrate random copolymer (molar fraction of vinylpyrrolidone monomer unit: 60%, number average molecular weight: 8,500) as the copolymer, a PET filter was prepared by the method of manufacturing a PET filter. A thrombus formation test of the PET filter thus obtained showed that no thrombus was formed as shown in Table 2.

### EXAMPLE 14

Using an N-vinylacetamide/vinyl pivalate random copolymer (molar fraction of vinylpyrrolidone monomer unit: 50%, number average molecular weight: 7,700) as the copolymer, a PET filter was prepared by the method of manufacturing a PET filter. A thrombus formation test of the PET filter thus obtained showed that no thrombus was formed as shown in Table 2.

### EXAMPLE 15

Using an N-isopropylacrylamide/ethyl acrylate random copolymer (molar fraction of N-isopropylacrylamide monomer unit: 50%, number average molecular weight: 3,000) as the copolymer, a PET filter was prepared by the method of manufacturing a PET filter. A thrombus formation test of the PET filter thus obtained showed that no thrombus was formed as shown in Table 2.

### COMPARATIVE EXAMPLE 8

A PET filter was prepared in the same manner as in Example 11, except that no copolymer was used and a thrombus formation test was performed. As a result, a thrombus was formed as shown in Table 2.

### COMPARATIVE EXAMPLE 9

A PET filter was prepared in the same manner as in Example 11, except that polyvinylpyrrolidone (manufactured by BASF Corporation; K30) was used in place of the vinylpyrrolidone/vinyl propionate random copolymer and a platelet adhesion test was performed. As a result, a thrombus was formed as shown in Table 2.

TABLE 2

| | | Situation of |
|---|---|---|
| | Name of polymer | thrombus formation |
| Example 11 | PVP/PVPr | Absent |
| | (molar ratio 60:40) | |
| Example 12 | PVP/PtVA | Absent |
| | (molar ratio 70:30) | |
| Example 13 | PVP/PVBu | Absent |
| | (molar ratio 80:20) | |
| Example 14 | PNVA/PtVA | Absent |
| | (molar ratio 50:50) | |
| Example 15 | PNIPAM/PEPR | Absent |
| | (molar ratio 50:50) | |
| Comparative | None | Present |
| Example 8 | | |
| Comparative | PVP | Present |
| Example 9 | | |

### INDUSTRIAL APPLICABILITY

The copolymer has an effect suppressing adhesion of proteins and platelets, and therefore can be used as a separation membrane and a medical device using the separation membrane. Particularly, the copolymer can be used as a blood purifier.

1-8. (canceled)

9. A copolymer, comprising two or more types of monomer units,
wherein
a hydration energy density of the copolymer calculated based on Formula (1) is 158.992 to 209.200 kJ·mol⁻¹·nm⁻³,
a monomer unit with a highest hydration energy density of monomer unit i calculated based on Formula (2) is a monomer unit not containing a hydroxy group,
a volume fraction of a monomer unit with a highest hydration energy density of monomer unit i calculated based on Formula (3) is 35 to 90%,
a difference in hydration energy density calculated by Formula (4) is 71.128 to 418.400 kJ·mol⁻¹·nm⁻³,
Hydrution energy density (kJ·mol⁻¹·nm⁻³) of copolymer=Σᵢ₌₁^{N}{(molar fraction of monomer unit i)×(hydration energy of monomer unit i)}/Σᵢ₌₁^{N}{(molar fraction of monomer unit i)×(volume of monomer unit i)} (1),
wherein the hydration energy of monomer unit i is an absolute value of a value obtained by subtracting energy in vacuum of monomer unit i from energy in water of monomer unit i, N represents a total number of monomer species constituting the copolymer, and i represents an integer of 1 or more and N or less,
Hydration energy density (kJ·mol⁻¹·nm⁻³) of monomer unit i=(hydration energy of monomer unit i)/(volume of monomer unit i) (2),
Volume fraction (%) of monomer unit with highest hydration energy density of monomer unit i=molar fraction of monomer unit with highest hydration energy density of monomer unit i×volume of monomer unit with highest hydration energy density of monomer unit i/Σᵢ₌₁^{N}{(molar fraction of monomer unit i)×(volume of monomer unit i)} (3),
wherein N and i are the same as defined above, and
Difference in hydration energy density (kJ·mol⁻¹·nm⁻³)=(hydration energy density of monomer unit with highest hydration energy density of monomer unit)−(hydration energy density of monomer unit with lowest hydration energy density or monomer unit) (4).

10. The copolymer according to claim 9, wherein
the hydration energy density of the copolymer is 167.360 to 200.832 kJ·mol⁻¹·nm⁻³,
the volume fraction of the monomer unit with the highest hydration energy density of monomer unit i is 40 to 80%, and
the difference in hydration energy density is 71.128 to 313.800 kJ·mol⁻¹·nm⁻³.

11. The copolymer according to claim 9, wherein the two or more types of monomer units comprise a hydrophobic monomer unit and a hydrophilic monomer unit.

12. The copolymer according to claim 11, wherein
the hydrophobic monomer unit is a repeating unit in a homopolymer or a copolymer obtained by polymerizing monomers selected from the group consisting of vinyl carboxylate, methacrylate, acrylate, and a styrene derivative, and
the hydrophilic monomer unit is a repeating unit in a homopolymer or a copolymer obtained by polymerizing monomers selected from the group consisting of an allylamine derivative, a vinylamine derivative, N-vinylamide, an acrylamide derivative, a methacrylamide derivative, N-vinyl lactam and N-acryloylmorpholine.

13. The copolymer according to claim 11, wherein
the hydrophobic monomer unit is a repeating unit in a homopolymer obtained by polymerizing vinyl carboxylate or a copolymer obtained by copolymerizing vinyl carboxylate, and
the hydrophilic monomer unit is a repeating unit in a homopolymer obtained by polymerizing N-vinyl lactam or a copolymer obtained by copolymerizing N-vinyl lactam.

14. A separation membrane, comprising the copolymer according to claim 9.

15. A medical device, comprising the copolymer according to claim 9.

16. A blood purifier, comprising the separation membrane according to claim 14.

17. The copolymer according to claim 10, wherein the two or more types of monomer units comprise a hydrophobic monomer unit and a hydrophilic monomer unit.

18. The copolymer according to claim 12, wherein
the hydrophobic monomer unit is a repeating unit in a homopolymer obtained by polymerizing vinyl carboxylate or a copolymer obtained by copolymerizing vinyl carboxylate, and
the hydrophilic monomer unit is a repeating unit in a homopolymer obtained by polymerizing N-vinyl lactam or a copolymer obtained by copolymerizing N-vinyl lactam.

19. A separation membrane, comprising the copolymer according to claim 10.

20. A separation membrane, comprising the copolymer according to claim 11.

21. A separation membrane, comprising the copolymer according to claim 12.

22. A separation membrane, comprising the copolymer according to claim 13.

23. A medical device, comprising the copolymer according to claim 10.

24. A medical device, comprising the copolymer according to claim 11.

25. A medical device, comprising the copolymer according to claim 12.

26. A medical device, comprising the copolymer according to claim 13.
